(19) United States
(12) Patent Application Publication
(10) Pub. No.: US 2006/0101048 A1
(43) Pub. Date: May 11, 2006

(54) KStore data analyzer

(76) Inventors: Jane Campbell Mazzagatti, Blue Bell, PA (US); Jane Van Keuren Claar, Bethlehem, PA (US); Tony T. Phan, Abington, PA (US); Haig C. Didizian, West Chester, PA (US)

Correspondence Address: Unisys Corporation;Attn: Mark T. Starr, Unisys Way, MS/E8-114, Blue Bell, PA, 19424-0001, US

(21) Appl. No.: 11/212,339

(22) Filed: Aug. 26, 2005

Related U.S. Application Data
(60) Provisional application No. 60/625,922, filed on Nov. 8, 2004.

(51) Int. Cl. G06F 17/00; G06F 7/00

(52) U.S. Cl. 707/101

(57) ABSTRACT

A data analysis system for performing an analytic to obtain an analytic result in a computing device having memory including a data analyzer interface, at least one interlocking trees datastore within the associated memory, and at least one analytic application executed. The data analysis system of the invention also includes a plurality of interlocking trees datastores wherein the at least one interlocking trees datastore is selected from the plurality of interlocking trees datastores in accordance with the data analyzer interface. The system can include a plurality of data sources wherein the at least one interlocking trees datastore is created from a data source selected from the plurality of data sources in accordance with the data analyzer interface. The at least one interlocking trees datastore further can be a static interlocking trees datastore or a dynamic interlocking trees datastore. The at least one interlocking trees datastore continuously records new data.

### BACKGROUND OF THE INVENTION

1. FIELD OF INVENTION.

This invention relates to computing and in particular to methods and systems for analyzing data relationships within a KStore interlocking trees data structure.

2. Description of Related Art

Corporations from all industries routinely store vast amounts of data in databases. The stored data can range from economic data relating to financial expenditures to scientific data collected during an experiment. Database users then take this data and query, or question, the database in the expectation of retrieving valuable information. Based on how present day databases are maintained and used, there are two scenarios that occur when a user queries a database.

In the first scenario, the user knows what types of information are contained in the database, knows the relationship between the data they are looking for, and knows of a way to search for it. The first scenario is most often characterized by the application of a single analytic, known to produce results, on the database. Examples of the first scenario are where the user desires to create graphs or charts, such as the rate of profit increase by a financial institution or a chemical company's research data showing changes in chemical diffusion across a cellular membrane. The output generated when an analytic is applied is an answer to a known query of a known relationship between known pieces of data.

The second scenario occurs when the user does not know what, if any, relationships exist between data within a database or databases. The user is presented with the daunting task of finding answers to questions based on these unknown relationships. Because of this, the users must focus not on what they know about the data, but rather, on what they do not know about the data. It is in this second scenario where the user employs a process called Data Mining, or Knowledge Discovery in Databases (KDD). The mining of databases through the application of analytics enhances the user's understanding of the data that is being collected.

Data Mining is the process by which raw data, collected and stored in a database warehouse, is analyzed using single or multiple analytics to find previously unknown relationships or patterns between the data. The result of the query is not the pattern of data that the user knows about, but rather, the result is the pattern, or more frequently patterns, the user does not know about. Although the application of single or multiple analytics to a database can theoretically generate millions of patterns, the user will only want to retrieve relationships that contain useful knowledge, or, are interesting. Once the user mines the database and finds interesting patterns, the user can then limit the search fields of the applied analytics to focus the knowledge gained from Data Mining onto specific variables, further increasing the specificity or exactness of understanding of the knowledge contained in the database.

In the current state of the art, the process of mining a database for knowledge is common and well known to those skilled in the art. First, before the data miner application can be applied to a given database, the user determines what type of database the Data Miner will be applied to. Examples of the varying types of databases can be static databases such as warehouses or dynamic databases as used in real-time data sampling. The user then decides what Data Miner applications can be used and if any optimizations are necessary to prevent the retrieval of uninteresting or useless patterns. If the user determines that no current Data Miner applications exist for their particular situation, the user then creates a Data Miner application that fits his/her needs. The Data Miner then applies varying analytics, as prescribed by the user, to a database and attempts to find interesting relationships therein.

With the current art, the application of analytics is a standard operation. First, the user must either use an existing database or “seed” a new database with raw data. Then, the user must determine what types of data are needed to solve his particular need. The user then either devises and implements a script that mines the database and retrieves the needed data or the user implements a canned script already prepared by an outside source. Because of the nature of the database, being only populated with raw data with no relational data contained therein, in order for the analytic to be applied, the script often requires the setting up of tables that will be populated with the mined data. If the database is not in a form proper for the previously prepared analytic, the database may need to be reconstructed if key data is not in indexes that are searched for by the data miner. Once the table or tables are constructed and populated with the mined data, the script looks through the information and returns an output using the algorithm implemented by the analytic.

Methods for mining large amounts of complex data are fairly common in the art. For example, U.S. Patent Application Nos. 2004/0010505 entitled “Method and system for data mining automation in domain-specific analytic applications” teaches methods for using predefined data mining algorithms to mine data from a data schema.

U.S. Patent Application No. 2005/0069863, entitled “Systems and methods for analyzing gene expression data for clinical diagnostics” teaches methods, computer programs and computer systems for constructing a classifier for classifying a specimen into a class. The classifiers are models. Each model includes a plurality of tests. Each test specifies a mathematical relationship (e.g., a ratio) between the characteristics of specific cellular constituents.

U.S. Patent Application No. 2002/0077790, entitled “Analysis of retail transactions using Gaussian mixture models in a data mining system” teaches a computer-implemented data mining system that analyzes data using Gaussian Mixture Models. The data is accessed from a database, and then an Expectation-Maximization (EM) algorithm is performed in the computer-implemented data mining system to create the Gaussian Mixture Model for the accessed data. The EM algorithm generates an output that describes clustering in the data by computing a mixture of probability distributions fitted to the accessed data.

There are several limitations with the current state of the art of analytics and in turn, current Data Mining applications. First, it may take excessive human capital to implement an analytic. Data is collected and stored in raw form in a database. If the database is not indexed in the format necessary for a canned analytic to mine the database, either the database administrator must reconfigure the database or the administrator must modify the analytic so it can work within their particular database. This requires human capital because either the database administrator must compare how the user's database is formulated and alter it in a way that the canned analytic can be applied, or the corporation must enlist the help of programmers to re-write the analytic script so that it may be applied to their particular database, or, the programmers may have to write an entirely new analytic depending on the amount of changes that are required.

Second, valuable computer resources are taken away from computing and reallocated towards the application of an analytic. If a database is not indexed in the format needed to apply a particular analytic, the database would either need to be re-indexed or be completely reconstructed. The application of an analytic often requires the generation of a tables. If the tables need to be updated based upon a determination that the database contains new data, the analytic must repopulate the tables with an entirely fresh set of data which includes not only any new or updated data, but also, the already mined data. In addition, if subsequent applications of different analytics require information that is not contained in the existing tables, new tables would need to be created or the existing tables would need to be expanded with the additional data required for this new analytic. If the previous table contains excess information, or if the tables have to be updated or refreshed with new data, the system will have to unnecessarily populate these tables with extra data carried forth from the previous analytic.

All references cited herein are incorporated herein by reference in their entireties.

### BRIEF SUMMARY OF THE INVENTION

A data analysis system for performing an analytic to obtain an analytic result in a computing device having memory associated therewith, the data analysis system including a data analyzer interface, at least one interlocking trees datastore within the associated memory of the computing device, and at least one analytic application executed by the computing device. The data analysis system of the invention also includes a plurality of interlocking trees datastores wherein the at least one interlocking trees datastore is selected from the plurality of interlocking trees datastores in accordance with the data analyzer interface. The system can include a plurality of data sources wherein the at least one interlocking trees datastore is created from a data source selected from the plurality of data sources in accordance with the data analyzer interface. The at least one interlocking trees datastore can be a static interlocking trees datastore or a dynamic interlocking trees datastore. The at least one interlocking trees datastore continuously records new data.

The at least one interlocking trees datastore includes records of data and the at least one interlocking trees datastore continuously receives updates of the records of data. The at least one analytic application is selected from the plurality of analytic applications in accordance with the data analyzer interface. The at least one analytic application analyzes a static interlocking trees datastore or a dynamic interlocking trees datastore. The at least one analytic application can be any type of analytic, including an accounting/mathematical functional category analytic, such as a sum analytic, a statistical functional category analytic, a classification functional category analytic, a relationship functional category analytic, a visualization functional category analytic, a statistical functional category analytic, a meta-data functional category analytic or any other further functional category analytic. The data analyzer interface provides access to at least one administration application.

A data analysis method for performing an analytic to obtain an analytic result in a data processing device having a memory associated therewith, includes providing a data analyzer interface for the data processing device and storing at least one interlocking trees datastore in the memory of the data processing device. At least one analytic application is executed in accordance with the at least one interlocking trees datastore. The associated memory of the data processing device includes a plurality of interlocking trees datastores further and the at least one interlocking trees datastore is selected from the plurality of interlocking trees datastores in accordance with the data analyzer interface. The data processing device includes a plurality of data sources further and the at least one interlocking trees datastore is created from a data source selected from the plurality of data sources in accordance with the data analyzer interface. The data processing device includes a plurality of analytic applications further comprising selecting the at least one analytic application from the plurality of analytic applications in accordance with the data analyzer interface.

The KStore Data Analyzer overcomes the inherent limitations associated with the prior art of Data Analysis or Mining, that use traditional relational databases by using KStores that model the data, in combination with the application of a unique set of analytics called KStore Analytics. These KStore Analytics take advantage of the information contained in the Knowledge Store (KStore) interlocking trees data structure. As described in U.S. patent application Ser. Nos. 10/385,421, entitled “System and method for storing and accessing data in an interlocking trees datastore” and 10/666,382, entitled “System and method for storing and accessing data in an interlocking trees datastore” the KStore data structure does away with the distinction between transactional data and stored (relational) data.

It is through this combination, the use of a KStore structure and analytics specifically designed for that structure, that many of the limitations with the prior art are overcome. First, human capital costs are reduced. When the KStore Engine is applied to static data or data from an existing database that has been previously populated, or dynamic data that is being populated on a timely basis, the KStore Engine formulates all the relationships upon data entry. Therefore, an interlocking tree datastore administrator or user does not need to verify that the data is set up in a specific way because the KStore Engine has already performed the task prior to analytic application. Also, because the KStore Engine models data in a consistent manner based on specific rules, the interlocking trees datastore administrator or user does not need to determine if certain analytics can be applied to the data while others cannot. Because the analytics use the structure of the KStore, various analytics in varying combinations, if desired, can be applied to the KStores regardless of the original data input.

Second, computer resources are not unnecessarily used for processes such as table generation or excess data updating. The KStore Data Analyzer implements analytics that take advantage of the relational information already contained in the KStore, removing the need to create tables to determine that information, as is the case in the prior art. The process by which KStore Analytics analyze the data allows for the application of various analytics to interlocking trees datastores without the need to generate a table for each analytic. Further, because no tables are generated, valuable computing resources are not needed to repopulate tables with excess data should a user want to use more than one analytic on a data set when those analytics require different data. KStore Data Analyzer using KStore Analytics on KStores only use minimal resources because the KStore Engine has already learned and developed the KStore structure based on all possible relationships between the data.

Because the present invention overcomes the limitations of the previous art, the KStore Data Analyzer provides levels of flexibility and agility for the user previously not found in prior art Data Mining techniques. Not only can various analytics in various combinations be applied to the same data without the need to generate tables, the same analytic can also be applied to various KStores because all analytics are optimized to work on the same modeling of information by the KStore Engine. KStore Analytics also provide the flexibility of implementing queries that are able to run while the structure is being populated.

The KStore Analytics also provide flexibility in personnel support. KStore administrators would need little or no understanding of the structure of the data or of the information contained therein. The KStore Analytics mine the data and implement analytics based on the knowledge the KStore Engine generates while populating the interlocking trees data store. An administrator would only need to know that the data had been placed in a KStore structure in order to be able to use any of the KStore Analytics.

### BRIEF DESCRIPTION OF SEVERAL VIEWS OF THE DRAWINGS

The invention will be described in conjunction with the following drawings in which like reference numerals designate like elements and wherein:

FIG. 1A shows a block diagram representation of an embodiment of a KStore system suitable for practicing the system and the method of the present invention.

FIG. 1B shows a graphical representation of an interlocking trees datastore.

FIG. 2 shows a screen shot of a graphic user interface suitable for use as the KStore Administration main window, which a user may access to instantiate the KStore Data Analyzer and also for use with the KStore Analytic Views Tab which a user may access analysis functions.

FIG. 3 shows a screen shot of a graphic user interface suitable for use with the KStore Sum Column analytic to return the sum of numeric values in a given data set.

FIG. 4 shows a screen shot of a graphic user interface suitable for use with the KStore Distinct Count analytic to return the count of distinct values in a given data set.

FIGS. 5A, B show screen shots of a graphic user interface suitable for use with the KStore Single Variable Prediction analytic, which returns the probability of a focus variable.

FIGS. 6A, B show screen shots of a graphic user interface suitable for use with the KStore Contexted Classification analytic, which returns the classification of a sample X within a context.

FIGS. 7A, B show screen shots of a graphic user interface suitable for use with the KStore Bayes Classification analytic, which returns the classification of a sample X using Bayes theorem.

FIG. 8A shows a decision tree of the sample data used in this patent.

FIGS. 8B, C show screen shots of a graphic user interface suitable for use with the KStore Dynamic Decision Tree analytic, which creates a decision tree representation of a given data set which may be used to classify a sample X.

FIG. 9 shows a screen shot of a graphic user interface suitable for use with the KStore Associated Rule Set analytic, which returns a list of variables or combinations of variables and their probability of co-occurring with a focus variable.

FIGS. 10A, B show screen shots of a graphic user interface suitable for use with the KStore Market Basket analytic, which returns a list of variables and combinations of variables and their probability of co-occurring with a focus variable.

FIG. 11 shows a screen shot of a graphic user interface suitable for use with the KStore Tools Tab, which a user may access to instantiate various KStore Tools and Utilities.

FIG. 12 shows a screen shot of a graphic user interface suitable for use with the KStore Data Source Tab, which a user may access to instantiate the KStore Load Utility.

### DETAILED DESCRIPTION OF THE INVENTION

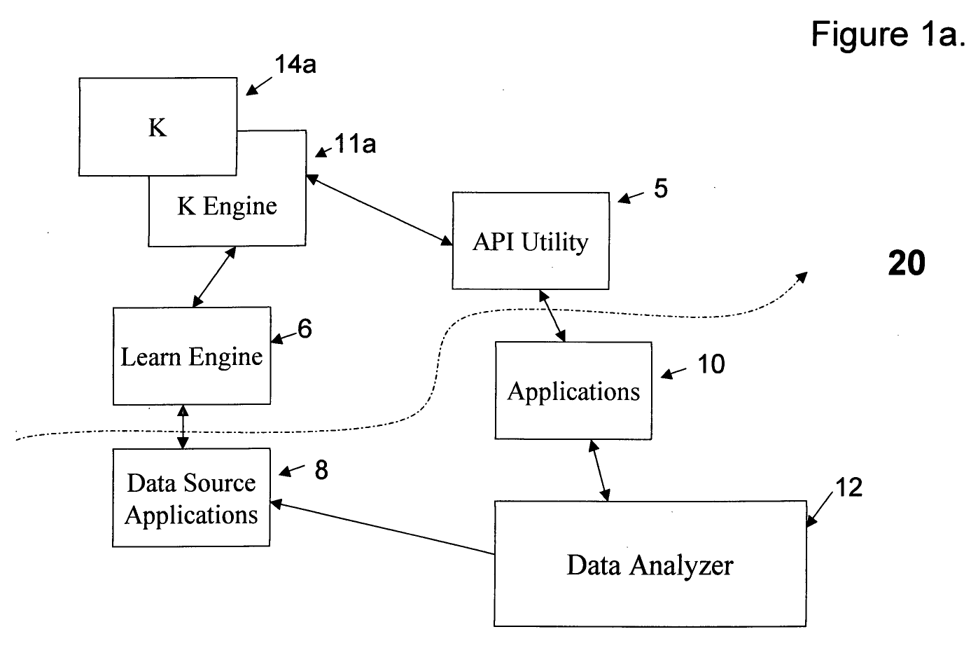

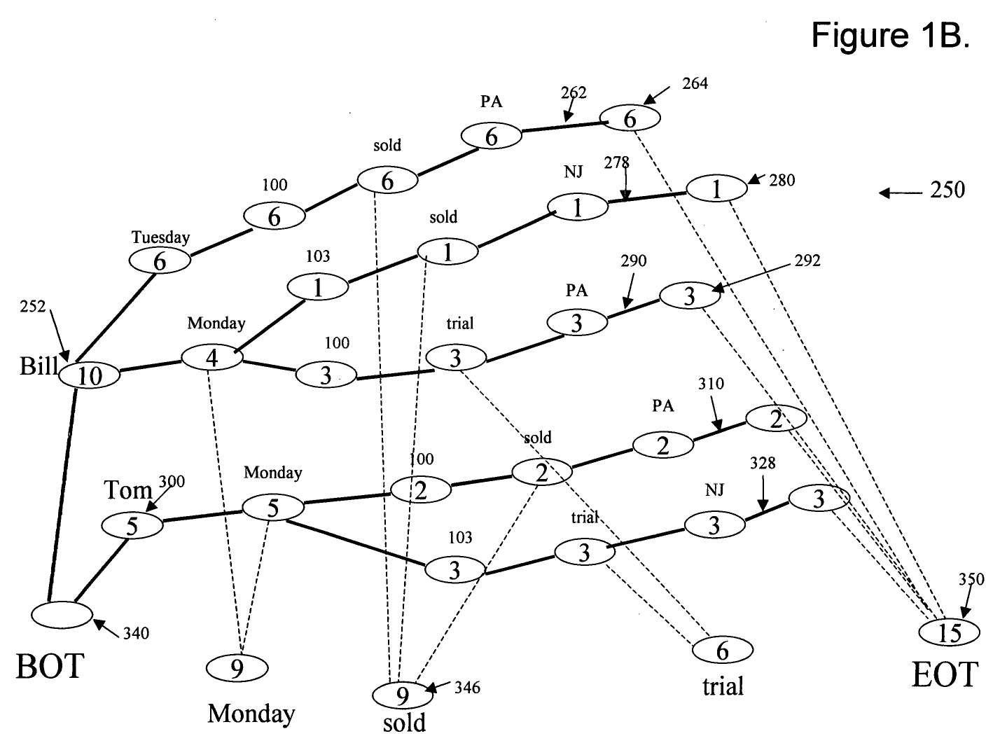

Referring now to FIG. 1A, there is shown a preferred embodiment KStore environment 20 suitable for practicing the system and method of the present invention. The KStore, also referred to as “K”, 14a is accessed by the rest of the KStore environment 20 by way of a K Engine 11a. In particular the K Engine 11a can communicate with a learn engine 6 using data source applications 8 and an API Utility 5 which interfaces with applications 10. The selection of the data source applications 8 and the applications 10 may be selected under the control of the data analyzer 12 as described in more detail below.

When the KStore Engine processes particles of a data stream, the KStore Engine may record the events by generating Nodes based on relationships between two pieces of information. The resulting Nodes, which do not connect but rather relate two pieces of information, may contain two pointers, one pointer being the Case and the other, the Result. As the number of times the same relationship between the same two pieces of information occurs, or more accurately as the number of times the same Node is traversed during a learn operation, the KStore Engine may increase a counter field to indicate the number of times the same relationship has been recorded into the KStore. The KStore Engine, along with building pointers and updating counts in the Node, also may build two pointer lists into the KStore interlocking trees data store for each Node. The first list may contain pointers to other Nodes that reference the current Node as a Case Node. The other pointer list may contain pointers to other Nodes that reference the current Node as Result Node.

Since it is possible to retrieve every possible count of every value in every context represented in a KStore, a KStore is capable of supporting any possible analytic, descriptive or predictive, static or in real-time. Therefore, the KStore Analytics implemented by the KStore Data Analyzer may return useful patterns containing knowledge using any analysis technique from either a static or dynamic KStore. The KStore Data Analyzer uses the knowledge from the pointers and pointer lists contained in the Nodes to retrieve relational information about the data and uses the count fields to perform statistical analysis of those relationships. In addition, the sequences of events captured within the interlocking trees data store may also be used for analysis of the data.

The KStore Data Analyzer may exist in either a batch environment or in an interactive environment. The various KStore applications, including Analytics, Utilities, and Data Sources that the KStore Data Analyzer utilizes may also exist in either a batch or interactive mode, depending upon the requirements of the specific KStore environment. In a preferred embodiment, the KStore Data Analyzer is used in an interactive environment and may use at least two types of Graphical User Interfaces (GUIs) to assist the user in performing data mining operations on interlocking tree datastores.

The first type of GUI is a KStore Administration interface which provides access to administration functions, including definition of data sources, as well as all the analytics currently available to the user. This interface performs the functions of the data analyzer 12, including selecting a specific analytic application from applications 10 and specific data sources from data source applications 8. In addition, the interface may provide access to functions other than analytics in the KStore applications 10 which, for instance, may include Save/Restore routines that provide persistence for the KStore data structure.

The second type of GUI provides a specific interface for a user selected analytic application as shown in applications 10. The format for an analytic interface depends upon which analytic was chosen and may contain various fields, or directives which include, among others, the focus variable currently in use, any constraints, results required, and what KStores are being mined.

Along with the previously mentioned fields and directives, in order to help the user sort through and narrow the resulting knowledge to a desired specificity, the analytic may display selectable constraint lists and focus variables. A constraint list contains constraints that are variables that limit the records a query will process whereas the focus is generally a variable value that is the subject of interest, usually within a context defined by a set of constraints. For example, a basic query could return the total number of widgets sold. To reduce the total number of records analyzed, the user could constrain the KStore by a specific salesman in order to determine the total number of widgets sold by that salesman. In the preceding example, the focus would be the number of widgets sold and the constraint would be the particular salesman.

KStore Analytics

KStore Analytics use information recorded by the KStore Engine and implement special analytic scripts that capitalize on this information. KStore Analytics use information contained in the KStore such as the number of occurrences of a variable and the relationship of that variable with the rest of the data in the KStore.

It will be understood that the analytics set forth herein are not intended to be exhaustive of all of the analytics possible in keeping with the spirit and scope of the invention. Rather, they are intended to be merely representative of the analytics that may be performed according to the invention.

KStore analytics may be implemented against a KStore by applying a focus and possibly one or more constraints to the KStore to obtain a result. The results obtained by the KStore Analytic are based on the result requested. The results include values such as numeric values or particle sequence values. Since the order in which values are recorded by a KStore is, in itself, information, sequence information is also a result that may be obtained by an analytic. An example of the use of sequence information by an analytic is an analysis of timings of banking transactions.

KStore Analytics may be grouped into any number of functional categories. The accounting/mathematical functional category includes such analytics as “Sum,” “Distinct Count,” and “Data Aggregation.” The statistical functional category includes analytics such as “Single Variable Prediction.” The classification functional category includes analytics such as “Contexted Classification,” “Bayes Classification,” and “Dynamic Decision Tree.” The relationship functional category includes analytics such as “Associated Rules”. The visualization functional category includes analytics such as “Chart Generator” and “Field Chart.” The meta-data functional category includes analytics such as “Constraint Manager.” Additionally, analytics can be divided into categories based on any criteria a user may find convenient. For example, a user may define a category of analytics that tend to be useful to users analyzing the results of drug studies. A user may also define a category of analytics that tend to be useful to users studying amino acids. Thus, the number of such functional categories is unlimited. The functional categories and the analytics in each functional category can be stored by the data analyzer 12 in FIG. 1A.

KStore Utilities

In addition to the functional analytics, the KStore Data Analyzer may provide access to various tools and utilities. These utilities may be used to load, save, restore, or simulate data, or to develop KStore-related GUI applications, among other functions.

In the following discussion, sample analytics and utilities will be defined and an example will be used with screen shots to show how each of these analytics may be accomplished. The examples are not meant to be an exhaustive list of examples, but are merely included to show how the KStore Analytics work with the information in KStore to analyze data.

Referring now to FIG. 1B, there is shown the interlocking trees datastore 250. The interlocking trees datastore 250 is a diagrammatic representation of a KStore 14a FIG. 1a that can be provided within the KStore Data Analyzer system 20. The structure and functioning of the interlocking trees datastore 250 is substantially as taught in copending U.S. patent application Ser. Nos. 10/666,382 filed Sep. 19, 2003 and 10/879,329 filed Jun. 29, 2004.

Data records such as the data records shown in the Table below can be imported into the interlocking trees datastore 250. The methods for building a KStore such as the K 14a FIG. 1a from data records such as those shown in the Table are also taught in the foregoing patent applications.

TABLE

| | | | | |
|---|---|---|---|---|
| Bill | Tuesday | 100 | sold | PA |
| Bill | Tuesday | 100 | sold | PA |
| Bill | Tuesday | 100 | sold | PA |
| Bill | Tuesday | 100 | sold | PA |
| Bill | Tuesday | 100 | sold | PA |
| Bill | Tuesday | 100 | sold | PA |
| Bill | Monday | 103 | sold | NJ |
| Bill | Monday | 100 | trial | PA |
| Bill | Monday | 100 | trial | PA |
| Bill | Monday | 100 | trial | PA |
| Tom | Monday | 100 | sold | PA |
| Tom | Monday | 100 | sold | PA |
| Tom | Monday | 103 | trial | NJ |
| Tom | Monday | 103 | trial | NJ |
| Tom | Monday | 103 | trial | NJ |

Accordingly, the fifteen data records of the Table set forth the information for a total of fifteen transactions which can be stored as shown in the datastore 250. The presence of fifteen data records in the datastore 250 is indicated by the count of the end of thought node 350 which is the sum of the counts of all end product nodes within the datastore 250. It will be understood that the term ‘transactions’ herein includes both the trials and the outright sales shown in the data records of the Table.

The paths representing the fifteen transactions of the Table within the interlocking trees datastore 250 include the K paths that contain the ‘Bill’ subcomponent node 252 and K paths that contain the ‘Tom’ subcomponent node 300. The ‘Bill’ paths 262, 278, 290 are the paths extending from the BOT node 340 through the Bill subcomponent node 252. The ‘Tom’ paths 310, 328 are the K paths extending from the BOT node 340 through the Tom subcomponent node 300.

Using the interlocking trees datastore 250 it is possible to determine, for example, that Bill had six sold transactions on Tuesday in Pennsylvania by referring to K path 262. Furthermore, it is possible to determine that he had one sold transaction on Monday in New Jersey by referring to K path 278. Additionally, it is possible to determine the total number of items sold by either Bill or Tom by determining the number of times ‘sold’ is used within the interlocking trees datastore 250. This information can be determined by obtaining the count of the sold elemental root node 346. The count in the sold elemental root node 346 is nine.

KStore User Interface

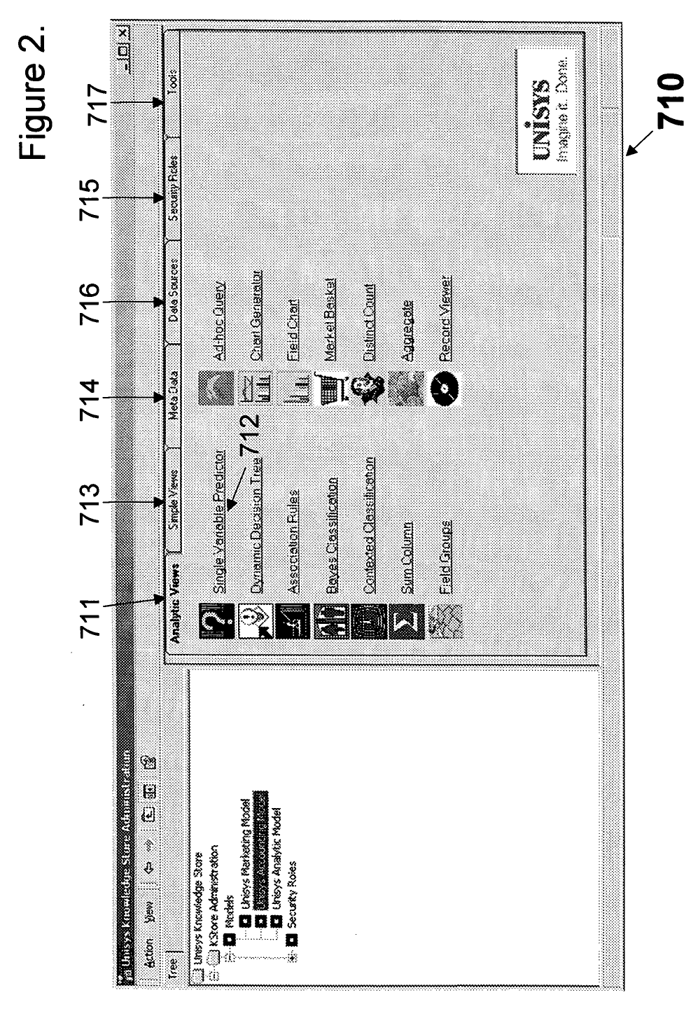

Refer to FIG. 2. FIG. 2 is a screen shot of the KStore Administration main window 710, which a user may access to use the KStore Analytics and Utilities. The tree panel on the left hand side of the window may be used to select which KStores are to be accessed. To view the set of analytics, the user may select the “Analytic Views” tab 711 or the Simple Views tab 713. All of the KStore Analytics discussed in the remainder of this patent may be linked from this main window. A user can click any name/link to open a functional window that allows the user to use a corresponding analytic. For example, clicking the “Single Variable Predictor” name/link 712 will open a functional window that will allow the user to use the single variable prediction analytic.

In the following discussion of the KStore Analytics, the user may start from the main window 710.

Accounting/Mathematical Functional Category

Many analytics provide basic math functions against the data, for instance the summing of columns. This functional category of analytics may include the analytics “Sum Column,” “Distinct Count,” and “Data Aggregation.” Each is discussed below.

Sum Column

The “Sum Column” analytic may return the sum of numeric values in a data set. Optionally constraints may be added to reduce the data set to specific records to sum. For example, the Sum Column analytic may calculate how many sofas Tom sold, or if the data set includes sales amounts, the analytic may calculate the total sales amount for a specific salesperson, such as Bill. The nodes on the asResult list of the Bill elemental root node (not shown) may be followed to the Bill subcomponent node 252 to determine a set of K paths which include Bill, paths 262, 278, 290. Traversing to the end product nodes 264, 280, 292 of Bill's K paths 262, 278, 290 a determination can be made whether any of these K paths also include the value “sold”. A determination is therefore made that K paths 262, 278 include the value “sold”. The corresponding end product nodes 264, 280 have counts 6 and 1, respectively. Additionally, Bill's K paths 262, 278 also include the values 100 and 103 for the Amount field, respectively. Thus, the “Sum Column” analytic for the amount returns the sum of (100×6)+(103×1) or 703.

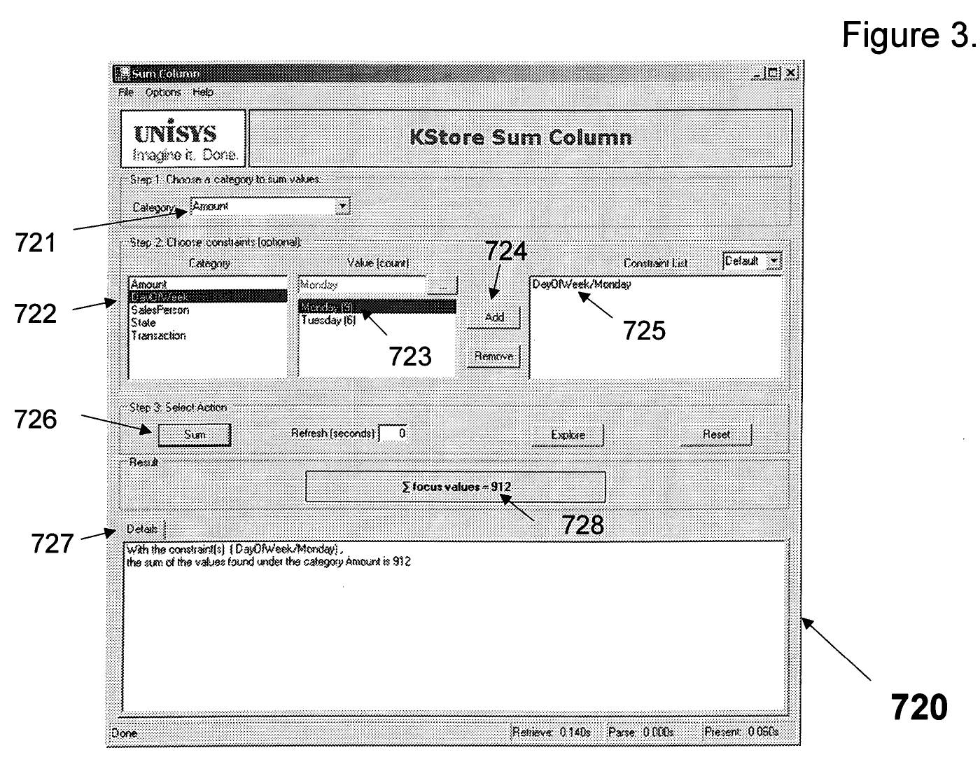

Refer to FIG. 3. FIG. 3 shows a screen shot of a KStore Sum Column user interface 720. In this example, the user may calculate the sum of sales for a given day of the week. To do this the user chooses a category or column to sum in Step 1 by selecting the name of the category, “Amount”. The user may then optionally constrain the data by selecting first the category “DayofWeek” 722 then the value “Monday” 723. The user can then press the “Add” button 724. The constraint “DayofWeek/Monday” displays in the “Constraint List” 725. The user can then press the “Sum” button 726. The result 912 is displayed in the Result box 728 and details about the calculation may be displayed under the “Details” tab 727.

Distinct Count

The “Distinct Count” analytic returns the number of distinct values in a given data set. With Distinct Count, duplicate values are not counted. For example, for the category or focus field “SalesPerson” in a given exemplary data set, there are only two values “Bill” and “Tom”. While there may be hundreds of occurrences of “Bill” and “Tom,” duplicates are not counted; only two distinct values for the focus “SalesPerson” are returned.

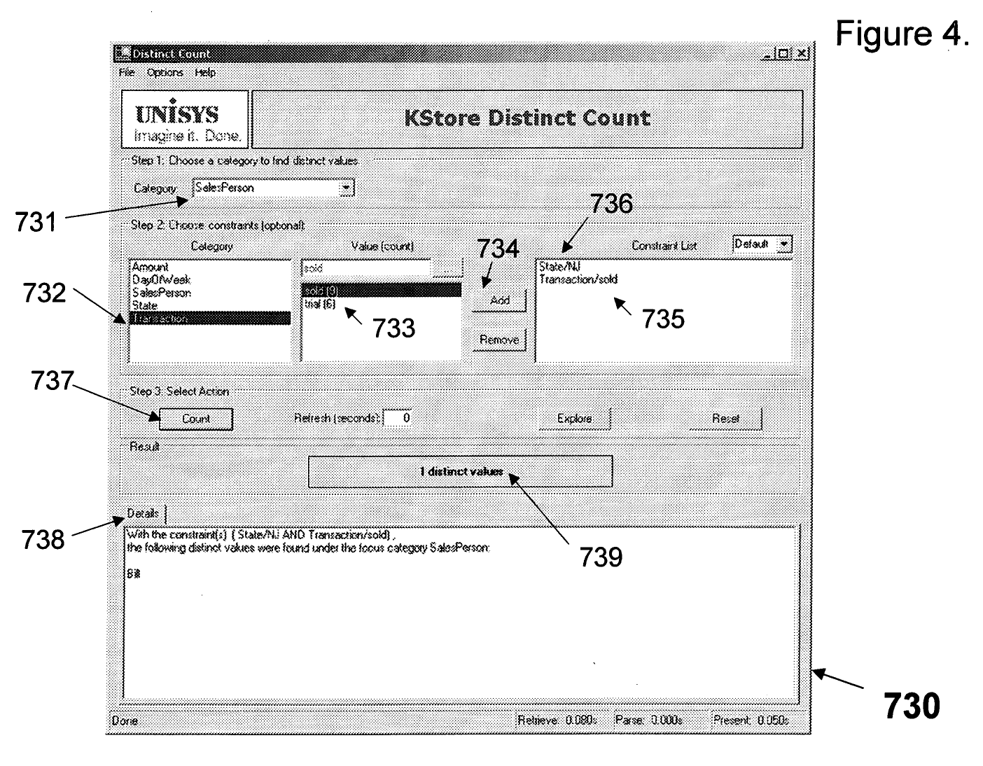

Refer to FIG. 4. FIG. 4 shows a screen shot of the KStore Distinct Count user interface 730. To determine a distinct count, the user selects a category, in this example, “SalesPerson” 731. The next step is optional. In this example, the user opts to further constrain the salesperson data by category Transaction 732 with a value sold 733 by selecting them and then pressing the Add button 734. “Transaction/sold” 735 displays in the “Constraints List” box. Notice that the user has already entered the constraint “State/NJ” 736. Therefore, in this example, the user wants to know the count of different salespersons who sold items in the State of New Jersey. The user continues by pressing the “Count” button 737. The results display in the Result box 739 with additional information about the calculation available under the “Details” tab 738. In this example, there was only one distinct value 739, or in other words, there was only one salesperson “Bill” with “sold” transactions in New Jersey.

Data Aggregation

Data aggregation is any process in which information is gathered and expressed in a summary (or aggregated) form for purposes such as statistical analysis. For example, daily sales data may be aggregated so as to compute monthly or annual total amounts. The KStore Data Aggregation analytic finds co-existence of items in a record and also performs numeric calculations on data as identified in user-defined queries. In one preferred embodiment, it performs a summation calculation. In alternate preferred embodiments of the invention it may perform calculations such as averaging, distinct count, distinct count percentage, distinct count ratio, record count, record count percentage, record count ratio, among others. The structure and methods of the KStore Data Aggregation analytic have been described in patent application Serial No. (TN406), entitled, “Data Aggregation User Interface and Analytic Adapted for a KStore.”

It will be understood by those skilled in the art that any number of additional analytics in the Accounting/Mathematical Functional Category can be defined by a user in keeping with the spirit and scope of the invention. For example, many such analytics are set forth in the Appendix. A person of ordinary skill in the art can determine the operations performed by other analytics in the Accounting/Mathematical Functional Category, whether it is listed in the Appendix or not. The skilled artisan can then write programs to implement the analytics according to the specifications of KStore technology in the same manner as such programs can be written according to the specifications of other types of database technologies.

Statistical Functional Category

Analytics that perform statistical calculations fall into this category. This functional category includes the analytic “Single Variable Prediction.”

Single Variable Prediction

The Single Variable Prediction analytic returns the probability of a focus variable. Any one of the variables in the data set may be designated as the focus variable. The probability of the focus variable is equal to the number of records containing the focus variable over the total number of records. The scope of the prediction may be optionally limited by constraints, which are typically one or more values that determine which records will be isolated for analysis. In this case, the probability of the focus variable is equal to the number of records containing the focus variable over the total number records within the set of constrained records.

Using the Table of data records above, upon application of the KStore Engine to the data, the KStore would have learned that there are 9 occurrences of the variable ‘sold’ in the 15 total records of the Table. Therefore, selecting ‘sold’ as the focus variable, the probability of it occurring in all the records is 9/15 or 60%. If the user selects ‘Bill’ as the constraint variable, then only the records containing ‘Bill’ are considered. Upon application of the KStore Engine to the data, the KStore would have learned that there are 7 occurrences of ‘sold’ in the total of 10 occurrences of ‘Bill.’ Therefore, the probability of the focus variable ‘sold,’ constrained by the variable ‘Bill’ is 7/10 or 70%. The data set can be constrained by more than one variable. Taking the data set above, in the context of ‘Bill’ and ‘Tuesday’ the probability of ‘sold’ is 100%. Some examples of the uses of this type of analytic are finding the probability of a single variable, or, in trend analysis using a series of single variable predictions using time as the constraint.

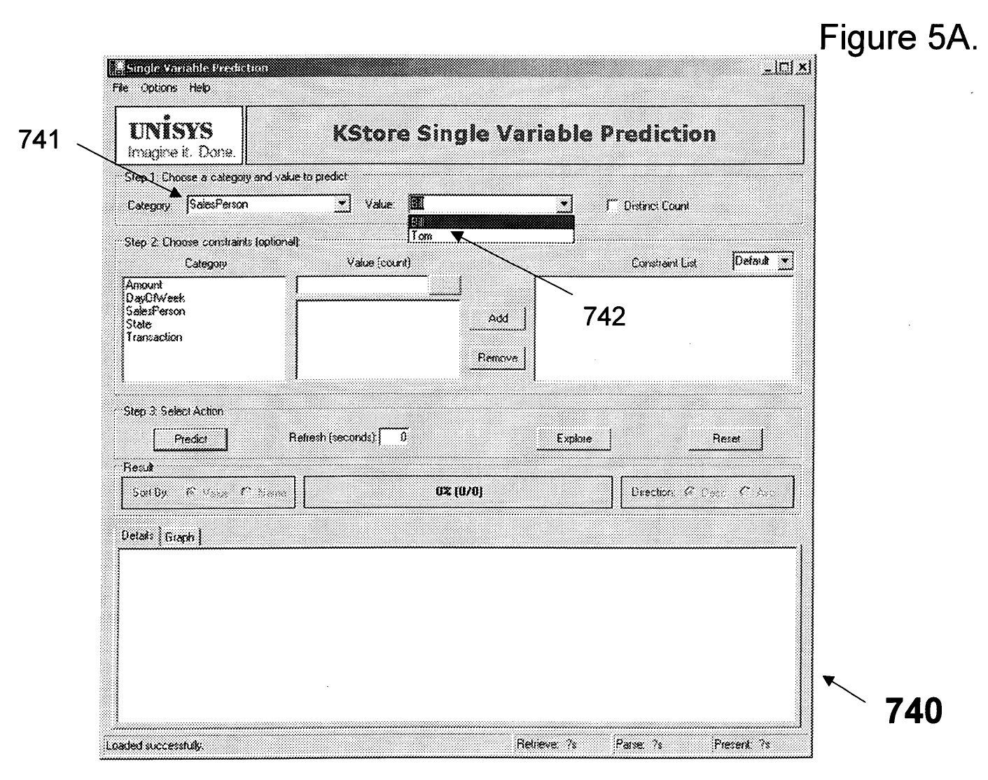

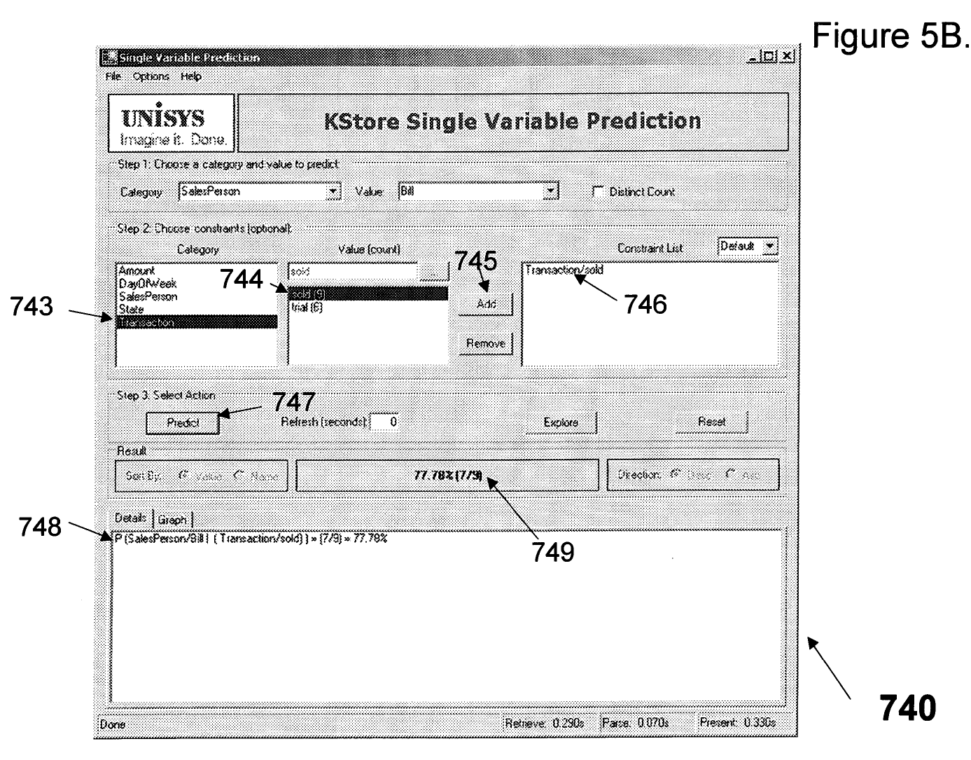

Refer to FIG. 5A. FIG. 5A shows a screen shot of a KStore Single Variable Prediction user interface 740. The user selects the category, “SalesPerson” 741 by clicking its name in the drop-down box. The user then selects the focus variable by selecting “Bill” 742 from the “Value” drop-down box.

Refer to FIG. 5B. FIG. 5B shows the same screen shot of the KStore Single Variable Prediction user interface 740. To add a constraint, the user selects the category in Step 2, “Transaction” 743 by clicking its name. The user then selects the constraint value “sold” 744 from the “Value” and pressing the “Add” button 745. “Transaction/sold” 746 displays in the “Constraint List” box. Finally, the user presses the “Predict” button 747. The result, 77.78% ( 7/9), appears in the Result box 749. Further details concerning the result may appear in the Details box 748. In this example, the analytic predicted for sales person “Bill” for transactions “Sold” 77.78%.

It will be understood by those skilled in the art that any number of additional analytics in the Statistical Functional Category can be defined by a user in keeping with the spirit and scope of the invention. For example, many such analytics are set forth in the Appendix. A person of ordinary skill in the art can determine the operations performed by other analytics in the Statistical Functional Category, whether it is listed in the Appendix or not. The skilled artisan can then write programs to implement the analytics according to the specifications of KStore technology in the same manner as such programs can be written according to the specifications of other types of database technologies.

Classification Functional Category

This functional category includes the analytics “Contexted Classification,” “Bayes Classification,” and “Dynamic Decision Tree,” each of which are explained below. Classification is a form of data analysis that can be used to extract models describing important data classes used for making business decisions. For example, a classification analytic may be used to categorize bank loan applications as either safe or risky.

Contexted Classification

The Contexted Classification analytic returns the classification of a sample X within a context. The data set is constrained by the sample variables so that only the records containing all the variables in the sample are considered and the highest probability variable of the classification field is chosen. This analytic will return no value if there are no instances of the specified context and therefore has a limited use when a decision is required. The variables are selected in a manner similar to the Single Variable Prediction analytic. Using the example record set above, if the sample X were ‘Bill’+‘Monday,’ there would be 4 records in the set. The probability of ‘sold’ would be ¼ and the probability of trial would be ¾. Therefore, the classification of the sample X would be ‘trial.’ This type of analytic can be used for such queries as credit risk analysis, churn analysis and customer retention.

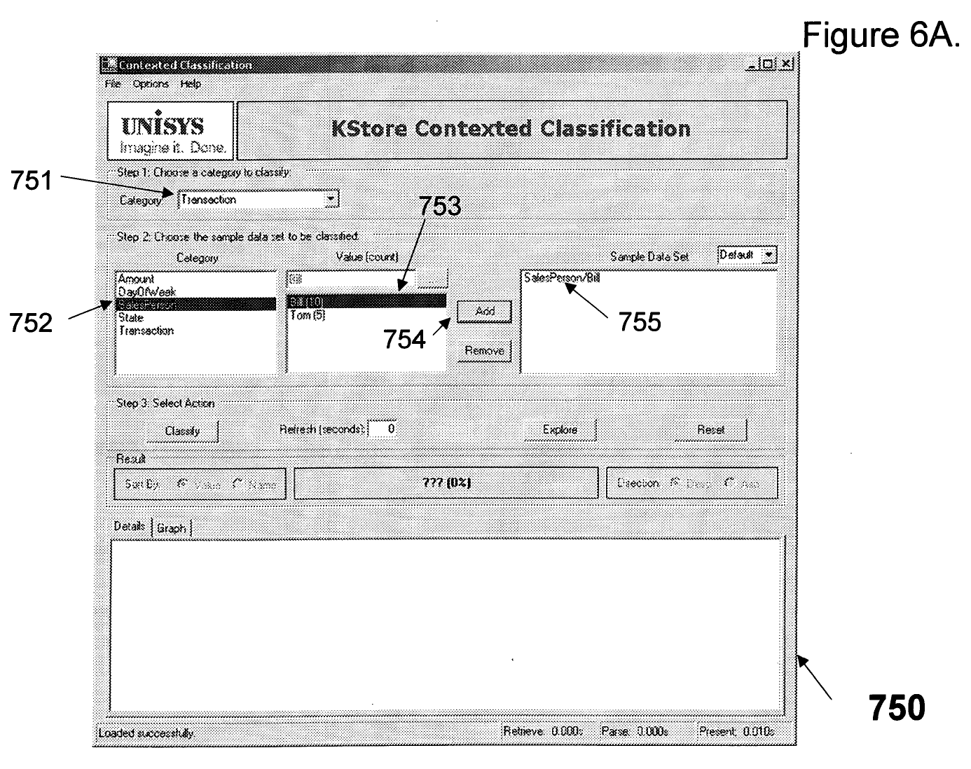

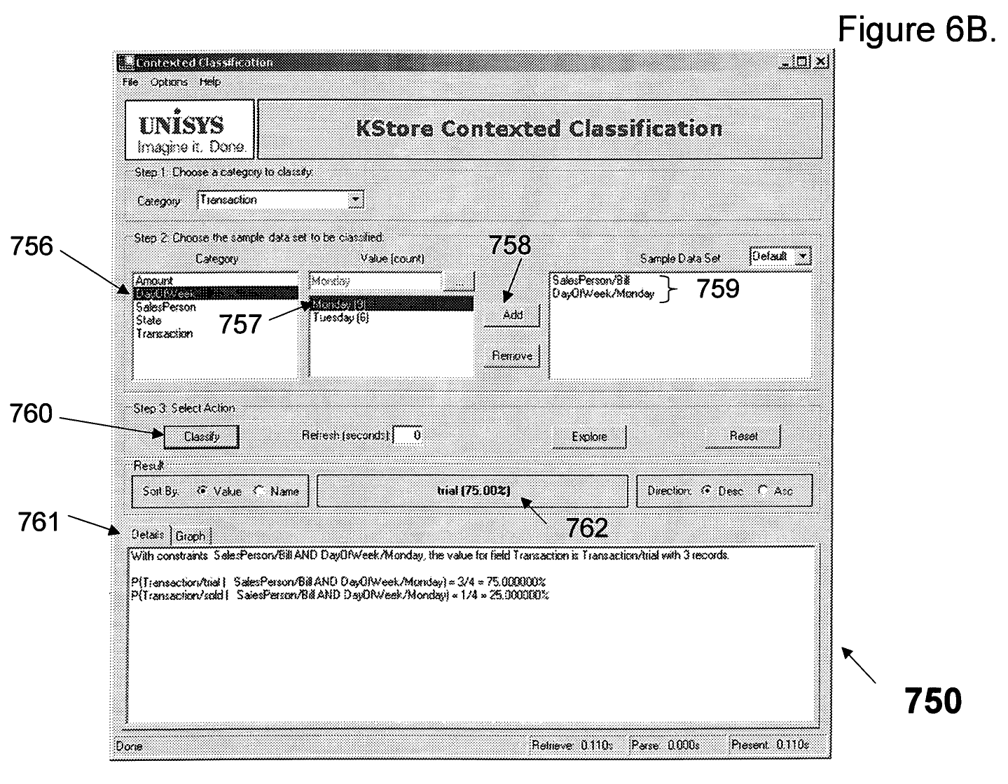

Refer to FIG. 6A. FIG. 6A shows a screen shot of the KStore Contexted Classification user interface 750. In this example, the first step for the user is to select the category “Transaction” 751 by clicking its name in the drop-down. Step 2 is for the user to select the category “SalesPerson” 752. The values available within the category “SalesPerson” include “Bill” 753. “Bill” 753 can be selected and the “Add” button 754 can be pressed. “SalesPerson/Bill” displays in the “Sample Data Set” box 755.

Refer now to FIG. 6B. FIG. 6B shows another screen shot of the KStore Contexted Classification user interface 750 during the process of performing the Contexted Classification analytic. The user can further constrain the sample by selecting “DayofWeek” 756 and “Monday” 757 and pressing the “Add” button 758. The sample is defined and displays within the “Sample Data Set” box 759. The user then performs Step 3 by pressing the “Classify” button 760. The result is displayed in the Result box 762, which in this instance is “trial(75.00%)”. Additional information available for the result may be found under the “Details” tab 761. As explained above, the probability of ‘sold’ would be ¼ and the probability of trial would be ¾. Therefore, the classification of the sample X would be ‘trial.’

Bayes Classification

Bayes classification is known to come in two probability models: naïve and full. This KStore analytic uses the Naïve Bayes probability model. Naïve Bayes is a technique for estimating probabilities of individual feature values, given a class, from data and to then allow the use of these probabilities to classify new records. A Naïve Bayes classification is a simple probabilistic classifier. Naïve Bayes classifiers are based on probability models that incorporate strong independence assumptions which often have no bearing in reality, hence are (deliberately) naïve. The probability model is derived using Bayes' Theorem (credited to Thomas Bayes). In spite of their naïve design and apparently over-simplified assumptions, Naïve Bayes classifiers often work much better in many complex real-world situations, such as for diagnosis and classification tasks.

The Naïve Bayes Classification analytic returns the classification of a sample X using Bayes theorem. For example, if the user wanted to classify the sample X (Tom, Tuesday) using the class variables as shown in column 4 of the sample data (sold and trial), the user would select the X variables and the class. Upon application of the KStore engine to the data, the KStore would have learned the number of occurrences of each variable and the relation of the variable to other variables. The analytic performs preliminary calculations:
P(sold)= 9/15=0.6
P(trial)= 6/15=0.4
P(Tom|sold)= 2/9=0.22
P(Tom|trial)= 3/6=0.5
P(Tuesday|sold)= 6/9=0.67
P(Tuesday|trial)= 0/6=0 (a small number such as 0.001 is actually used)
After it has performed the preliminary calculations, the Bayes Classification analytic would then apply the Bayes Theorem:
   P(X|sold)=0.22*0.67=0.15
   P(X|trial)=0.5*0.001=0.00005
   P(X|sold)P(sold)=0.15*0.6=0.09
   P(X|trial)P(trial)=0.0005*0.4=0.00002

The resulting P(X|sold)P(sold)=0.15×0.6=0.09 and the P(X|trial)P(trial)=0.0005×0.4=0.00002. Therefore the Naïve Bayes classifier predicts X=“sold.” Given “Tom” and “Tuesday,” the probability of items “sold” is higher than it is for items on “trial.”

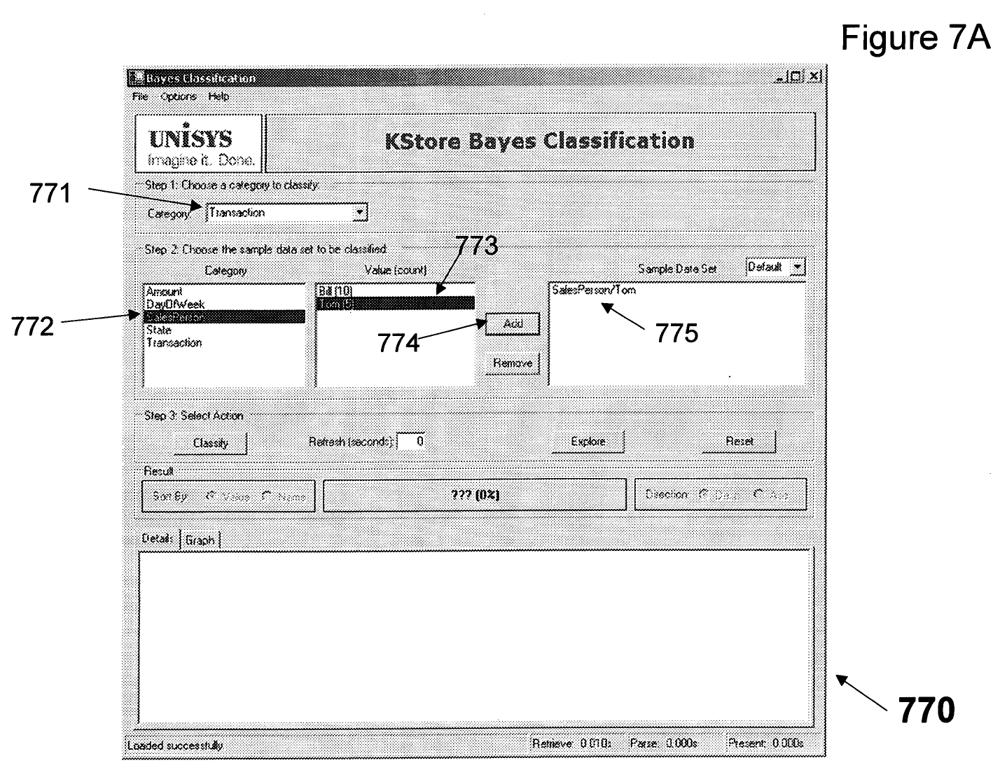

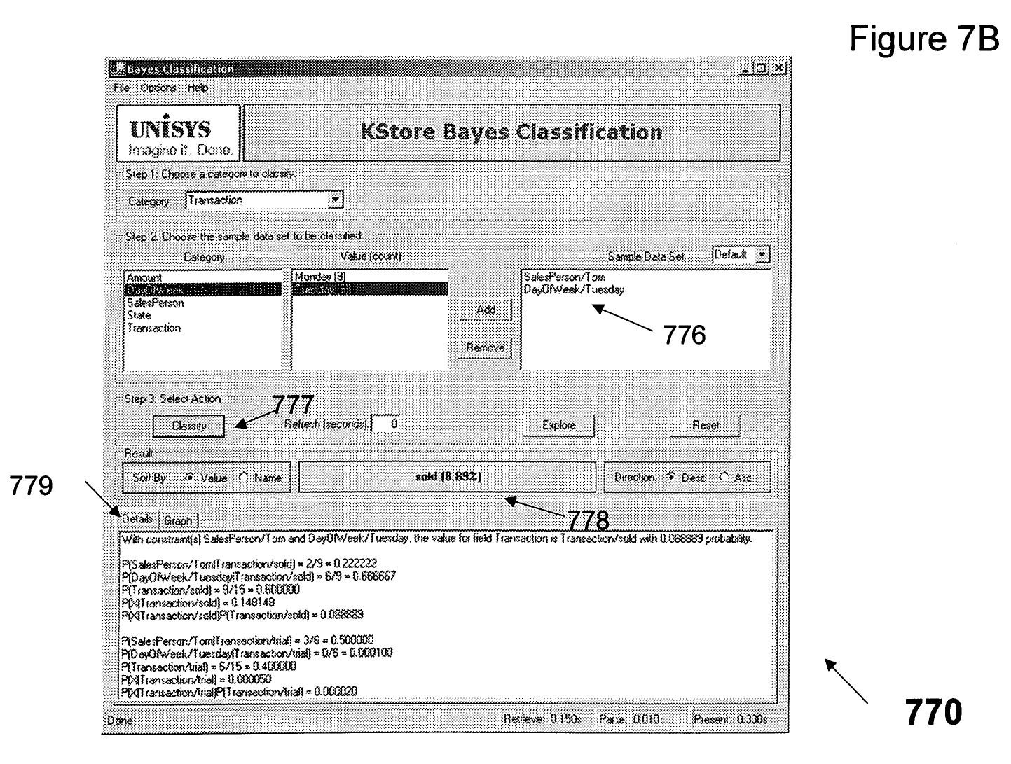

Refer to FIG. 7A. FIG. 7A shows a screen shot of the KStore Bayes Classification user interface 770. The first step the user performs is to select the category “Transaction” 771. To classify the sample X (Tom, Tuesday) the user would then, select the category “SalesPerson” 772, and then the value “Tom” 773. The user then presses the “Add” button 774. “SalesPerson/Tom” 775 displays in the “Sample Data Set” box.

Refer now to FIG. 7B. FIG. 7B shows a further screen shot of the KStore Bayes Classification user interface 770 during the process of performing the Bayes Classification analytic. The user next selects “Tuesday” by performing steps similar to those explained above for “Tom.” This culminates with “DayofWeek/Tuesday” 776 displayed in the “Sample Data Set” box along with the previously selected “SalesPerson/Tom”. The user then presses the “Classify” button 777. The result “sold (8.89%)” 778 displays and the detailed calculations appear under the “Details” tab 779.

Dynamic Decision Tree

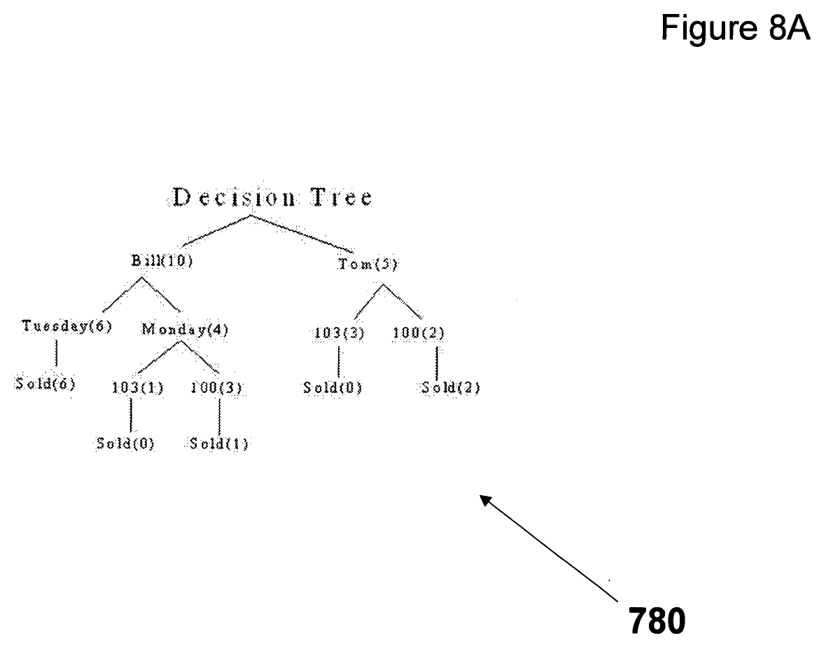

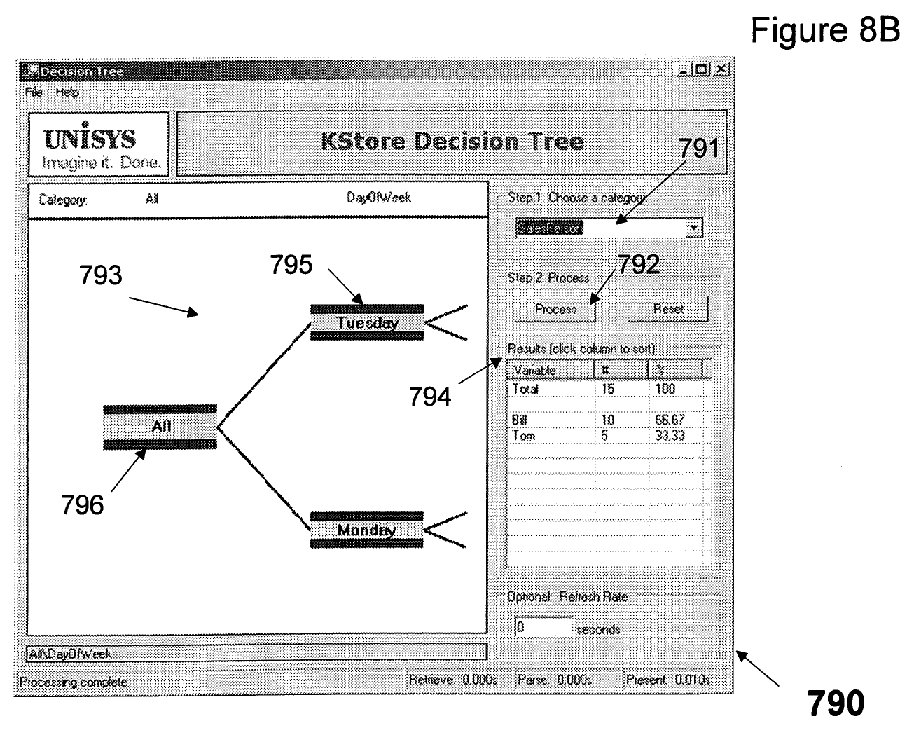

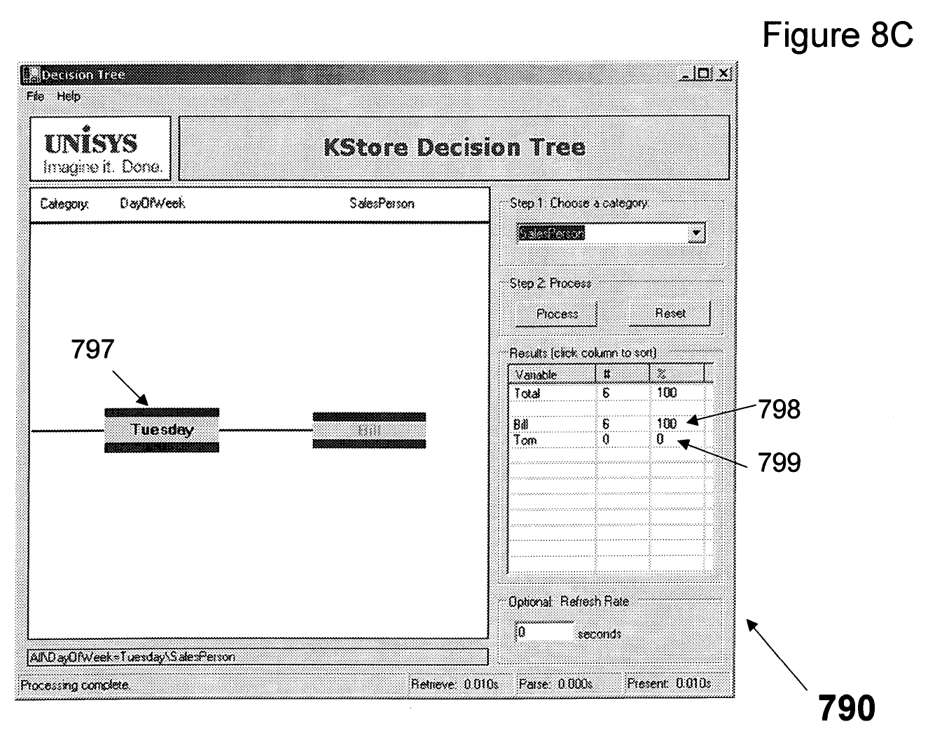

The Dynamic Decision Tree analytic creates a hierarchical tree representation of a given data set that may be used to classify a sample X. A tree consists of nodes and branches starting from a single root node. Nodes of the tree represent decisions that may be made in the classification of the sample. The goal is to be able make a classification for a sample using the fewest number of decisions or, in other words, by traversing the fewest number of nodes. Following each decision node, the data set is partitioned into smaller and smaller subsets until the sample has been classified. The analytic creates a decision tree by performing an analysis on the remaining categories or attributes at each node of the tree and, depending on the results of the analysis another set of branches and nodes is created. This process is followed until each tree path ends with a value of the desired classifier category. In this manner, a prediction (class assignment) may be made for a particular sample. Refer to FIG. 8A.

A focus or classification variable is selected, in this case ‘sold’. At each node the decision of which category variables to use for the branches is based on which variable contains the greatest number of the focus variable. Different decision trees may use different criteria for determining which categories to choose at each node level. Initially, the analytic reviews all categories over all the records. The records containing ‘Bill’ also contain the largest number of ‘sold’ (7 of the 10 ‘Bill’ records also contain ‘sold’.) So the category or column containing ‘Bill’ and ‘Tom’ is used to create the first branches. In the context (the set) of the ‘Bill’ records, all 6 of the ‘Tuesday’ records also contain sold, so the column containing ‘Tuesday’ and ‘Monday’ is used to create the next branches under ‘Bill’. The branching is complete when all the focus variables are accounted for. In the context of ‘Tom’, the column containing ‘103’ and ‘100’ is used to create the next branch. The column thatcontains ‘PA’ and ‘NJ’ could have also been used as the data distribution happens to be the same as for ‘103’ and ‘100’. A user may want to classify the sample X(Bill,Tuesday) using the class variables in column 4 (sold and trial). Classification can either be done visually by the user with the aid of the analytic GUI or presented as a response by the analytic itself. In this case, X has the probability for ‘sold’ of 100%. This type of analytic could be used for performing such queries as credit risk analysis, churn analysis, customer retention or advanced data exploration.

Refer to FIG. 8B. FIG. 8B shows a screen shot of the KStore Decision Tree user interface 790. To create a tree representation of a data set, the user's first step is to select a category to be used as the class. In this example, the user selects “salesperson” 791 from the drop-down box. The user then selects the “Process” button 792. The partial tree representation may be seen in display 793. At each node the decision of which category values to use for the branches is based on which category values will yield the most information about the classification category. Information about the classification category variables for the current tree node are displayed in the “Results” table 794. In this example, “Bill” and “Tom” are the variables contained within the focus or classification category. At the first node, the category of DayofWeek which contains the values Tuesday and Monday provide the shortest branches to classifying samples for SalesPerson. So the column containing both ‘Tuesday’ and ‘Monday’ is used to create the first branches. To traverse nodes, the user double clicks a node to move forward and backward in the tree. The results box 794 shows the value for each constrained dataset at that point. In this example we see the probabilities starting from the root of the tree, “ALL” indicating all records, 796.

Refer to FIG. 8C. FIG. 8C shows another screen shot of the KStore Decision Tree user interface 790. In this example, the user double-clicked the “Tuesday” node 797 from FIG. 8B. It can be seen in the “Results” table that the probability of “Bill” on Tuesday is 100% 798 and “Tom” on Tuesday is 0% 799.

Each node represents the occurrences of “Bill” and “Tom’ in the constrained data up to that point and selecting that node changes the values in the “Results” box.

It will be understood by those skilled in the art that any number of additional analytics in the Classification Functional Category can be defined by a user in keeping with the spirit and scope of the invention. For example, many such analytics are set forth in the Appendix. A person of ordinary skill in the art can determine the operations performed by other analytics in the Classification Functional Category, whether it is listed in the Appendix or not. The skilled artisan can then write programs to implement the analytics according to the specifications of KStore technology in the same manner as such programs can be written according to the specifications of other types of database technologies.

Relationship Functional Category

This category may be used to discover relationships among the data. This functional category may include the analytics “Associated Rules” and “Market Basket.”

Associated Rules

The Associated Rules analytic searches for interesting relationships among items in a given data set and returns a list of variables and combinations of variables and their probability of co-occurring with one or more focus variables. As a practical use of this analytic, association rules describes events that tend to occur together. The variables are selected in a manner similar to the Single Variable Prediction analytic. This type of analytic could be used for queries such as performing an advanced data exploration.

Using the sample data set, if the focus variable is “sold,” the analytic would use the information in KStore and make the following examples of calculations:
Level 1
   P(sold|Bill)= 7/10
   P(sold|Tom)=⅖
   P(sold|Tuesday)= 6/6
   P(sold|Monday)= 3/9
   . . .
Level 2
   P(sold|Bill+Monday)=¼.
   . . .

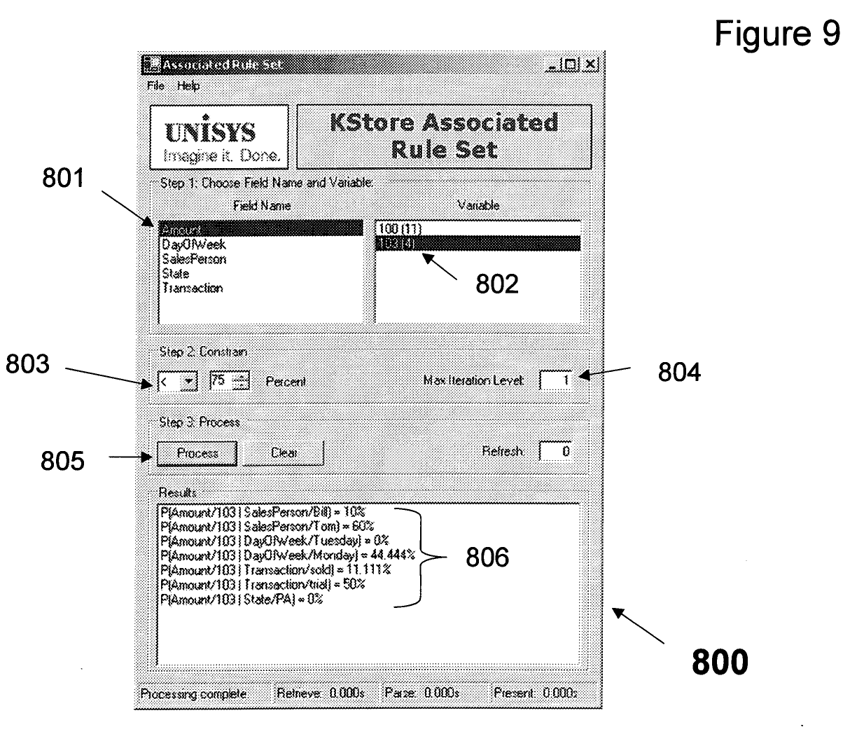

Refer to FIG. 9. FIG. 9 shows a screen shot of the KStore Associated Rules user interface 800. For this example, assume that the user wants to see the relationship between the Amount “103” and the other variables within the structure. The user first selects “Amount” 801 from the “Field Name” box and then selects “103” from “Variable” box 802. The user then selects how to constrain the data. In this example, the user selects “<75 percent” 803 (less than 75%). The user then selects the number of iterations or the maximum number of combinations of variables, by entering “1” in the “Max Iteration Level” box 804. The user then presses the “Process” button 805. The results display 806 shows the variable combinations that were found with a probability of less than 75%. Having selected the “1” iteration, the probability of “Amount/103” given “Salesperson/Bill” is listed as well as all other combinations with probabilities of less than 75%.

Market Basket

Market Basket Analysis may be used to determine which products sell together. In data mining, Market Basket Analysis is an algorithm that examines a list in order to determine the probability with which items within the list occur together. It takes its name from the idea of a person in a supermarket throwing all of their items into a shopping cart (a “market basket”). Market Basket Analysis may then be used to determine which products sell together. The results may be particularly useful to any company that sells products, whether it's in a store, a catalog, or directly to the customer. For example, market studies have shown that people who go into a convenience store to purchase one item, such as diapers, tend to purchase a non-related item, such as beer.

The KStore Market Basket analytic searches for interesting relationships among items in a given data set and returns a list of variables and combinations of variables and their probability of co-occurring with a focus variable.

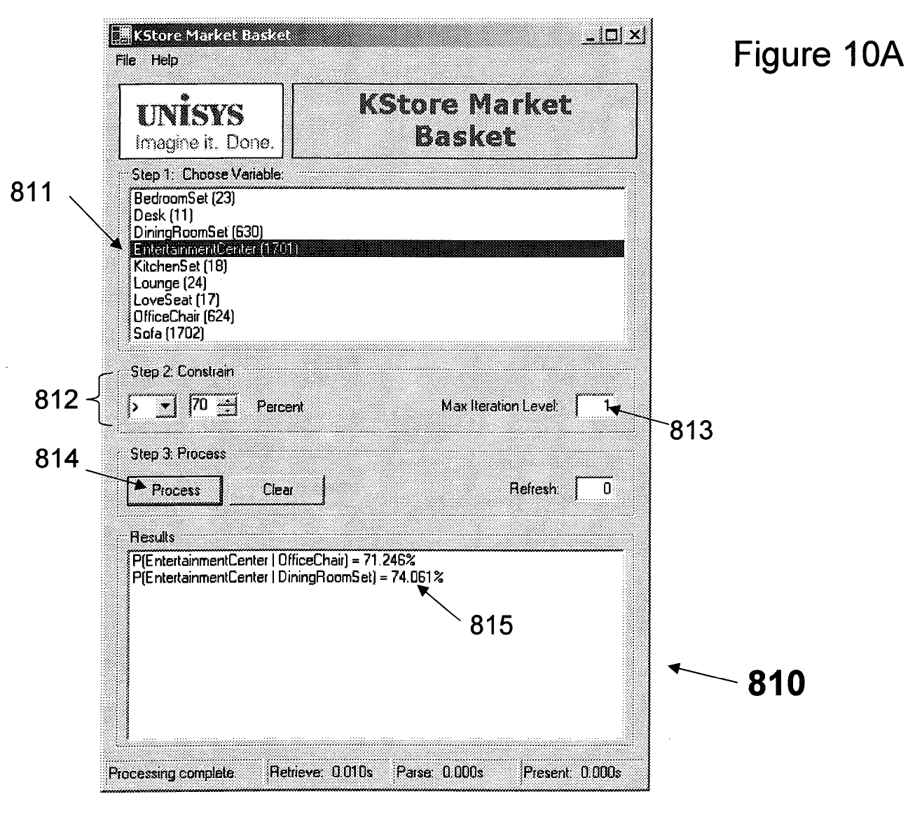

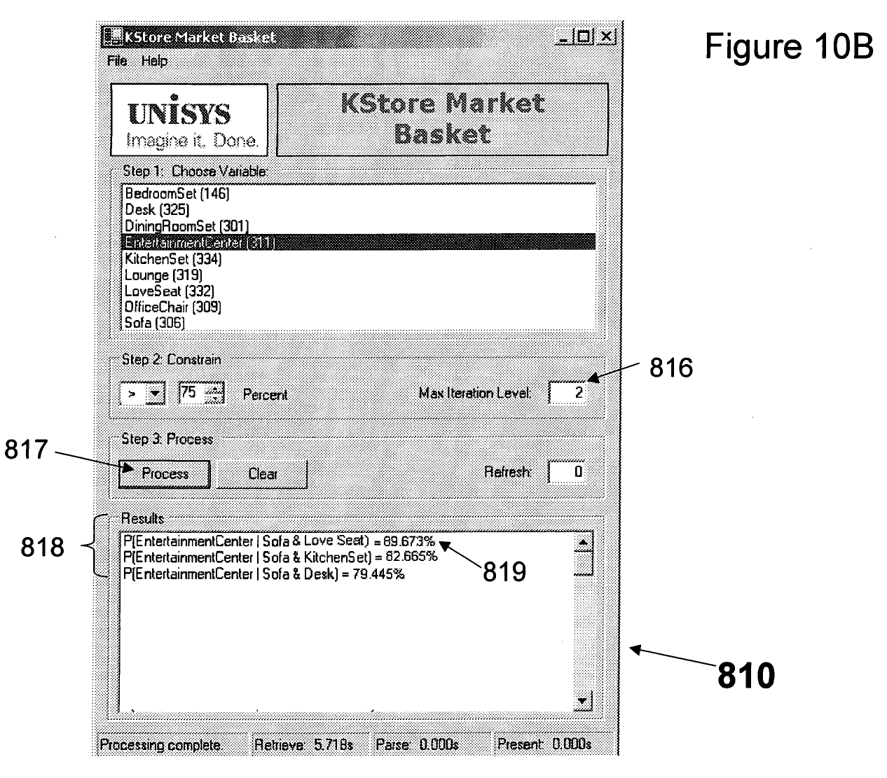

Refer to FIG. 10A. FIG. 10A shows a screen shot of the KStore Market Basket user interface 810. The data for this example contains lists of items purchased at a furniture store. In this first example, the user wants to see what other item is purchased when home entertainment centers are purchased. The user may want this information in order to design a sales promotion. The user first selects “EntertainmentCenter” from the list of variables 811. The user then sets the constraints to refine the results by selecting constraints under “Step 2: Constrain” 812. In this example, the user selected to constrain the results to those instances where home entertainment centers and another item were purchased at the same time more than 70% of the time. The user does this by selecting>70%. To determine the single most associated item, the user enters “1” in the “Max Iteration Level” box 813 and then presses the “Process” button 814. The results display under “Results.” In this example we see for every home entertainment center that was purchased, more than 74.061% of the time dining room sets were also purchased 815.

Refer to FIG. 10B. FIG. 10B shows a screen shot of the KStore Market Basket user interface 810. To see which one or two items are purchased when home entertainment centers are purchased the user enters “2” in the “Max Iteration Level” box 816 and then presses the “Process” button 817. The results display under “Results” box 818. Here we see for every home entertainment center purchased, more than 89.673% of the time sofas and love seats 819 were also purchased at the same time.

It will be understood by those skilled in the art that any number of additional analytics in the Relationship Functional Category can be defined by a user in keeping with the spirit and scope of the invention. For example, many such analytics are set forth in the Appendix. A person of ordinary skill in the art can determine the operations performed by other analytics in the Relationship Functional Category, whether it is listed in the Appendix or not. The skilled artisan can then write programs to implement the analytics according to the specifications of KStore technology in the same manner as such programs can be written according to the specifications of other types of database technologies.

Visualization Functional Category

This functional category may include the analytics “Chart Generator” and “Field Chart.” The structure and methods of KStore Chart Generator and Field Chart have both been described in patent application U.S. Ser. No. 11/014,494 filed Dec. 16, 2004.”

Chart Generator

KStore Chart Generator is a general method for providing a display of data such as charts and graphs, from an interlocking trees datastore in a graphical display system having a graphic display device. KStore Chart Generator analytic graphs the counts of the fields and values selected.

Field Chart

KStore Field Chart analytic graphs the occurrences of the categories selected.

It will be understood by those skilled in the art that any number of additional analytics in the Visualization Functional Category can be defined by a user in keeping with the spirit and scope of the invention. For example, many such analytics are set forth in the Appendix. A person of ordinary skill in the art can determine the operations performed by other analytics in the Visualization Functional Category, whether it is listed in the Appendix or not. The skilled artisan can then write programs to implement the analytics according to the specifications of KStore technology in the same manner as such programs can be written according to the specifications of other types of database technologies.

Meta-Data Functional Category

This functional category includes the analytic “Constraint Manager.”

Constraint Manager

KStore Constraint Manager enables the user to see associations or relationships that are not obvious in the raw data. Through the use of user-defined “constraints” (a field value or a field name/field value pair that limits a data set to only those records containing it) and “field categories” (a constraint set having a user defined logical relation between them), the KStore Constraint Manageranalytic is able to associate information in an interlocking tree data store.

It will be understood by those skilled in the art that any number of additional analytics in the Constraints Management Functional Category can be defined by a user in keeping with the spirit and scope of the invention. For example, many such analytics are set forth in the Appendix. A person of ordinary skill in the art can determine the operations performed by other analytics in the Constraints Management Functional Category, whether it is listed in the Appendix or not. The skilled artisan can then write programs to implement the analytics according to the specifications of KStore technology in the same manner as such programs can be written according to the specifications of other types of database technologies.

KStore Utilities

Besides the functional analytics discussed above, the KStore Data Analyzer provides access to various utilities some of which may be used to load, save and restore, simulate data, and develop KStore-related GUI applications. Each of these is discussed briefly below and are all subject to co-pending patents.

Save and Restore

“Save” and “Restore” refer to the structure and methods of saving an interlocking trees data store from memory to permanent storage and of restoring an interlocking trees data store from permanent storage to memory.

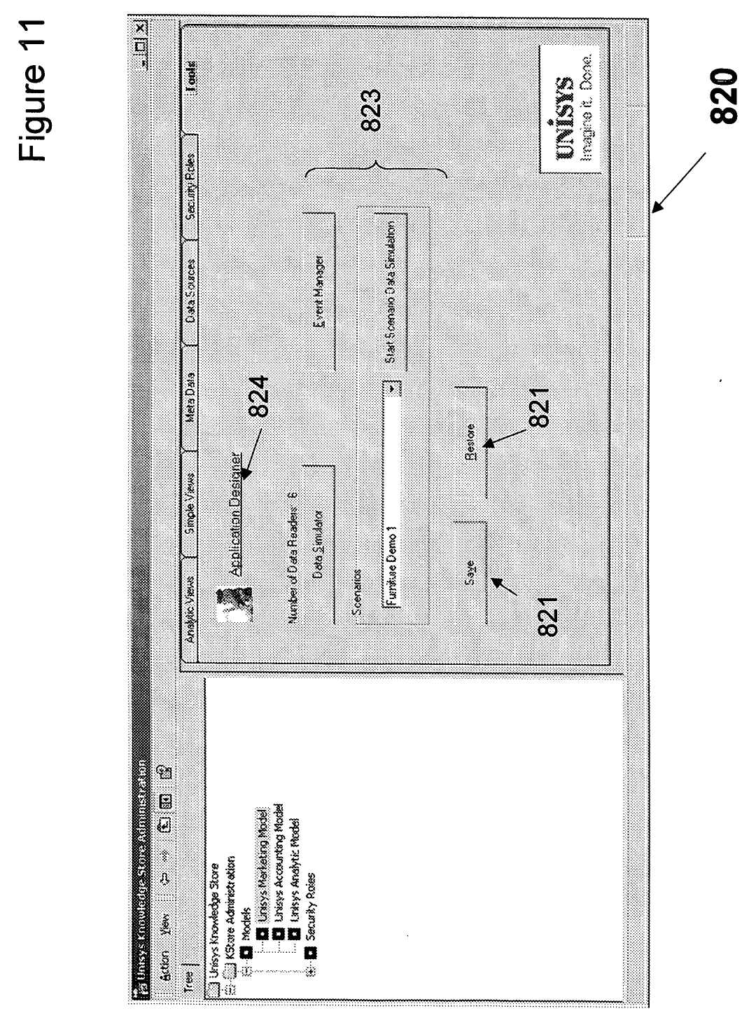

To use this feature, the user may select the “Tools” tab 717 from the KStore Administration main window 710 FIG. 2. Refer to FIG. 11. FIG. 11 is a screen shot 820 of the possible contents of KStore “Tools” tab. The “Save” button 821 and “Restore” button 822 appear on this tab.

“Save” and “Restore” has been described in patent application U.S. Serial No10/958,830 filed Oct. 5, 2004 entitled, “Saving and restoring an interlocking trees datastore.”

Data Simulation and Load

“Data Simulation” is a method for generating simulated data that randomly generates instances of data sequences (records). The simulator can be directed to generate one or multiple threads to test processor usage or to allow for the simulation of complicated data sets such as streaming data from multiple cash registers or sales people. This also allows for the simulation of data sets including data in different formats from different sources, such the data sets of sales data and data from inventory. “Load” refers to a method to load data into the K engine.

To use this feature, the user may select the “Tools” tab 717 from the KStore Administration main window 710 FIG. 2. Refer again to FIG. 11. FIG. 11 is a possible screen shot of the contents of KStore “Tools” tab 820. The “Data Simulation” buttons and drop-down 823 appear on this tab.

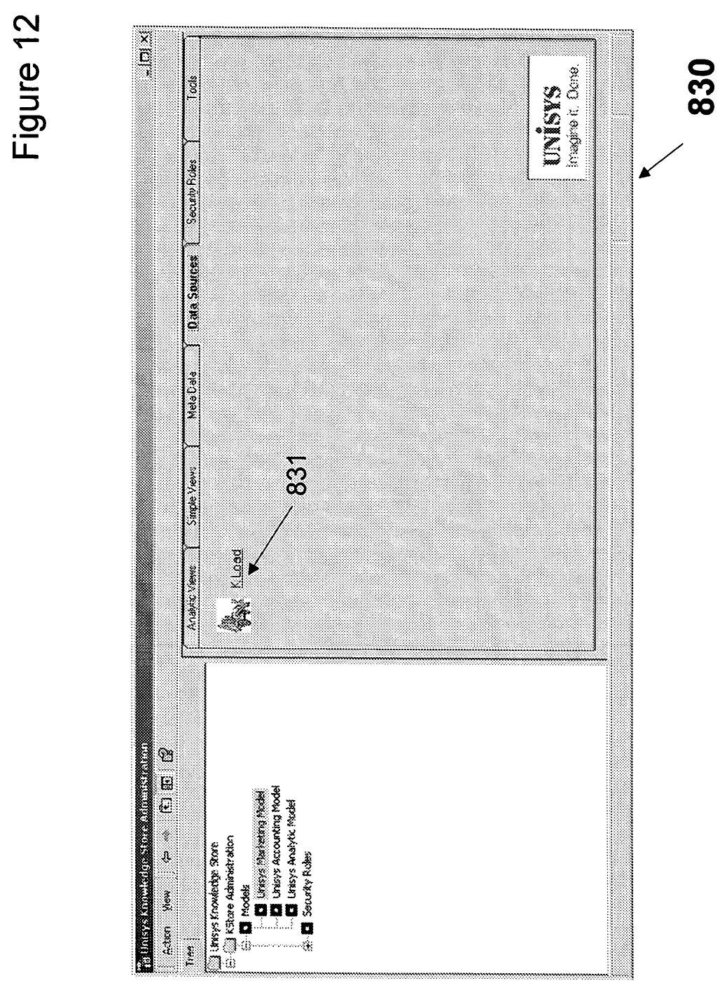

To use “Load,” the user may select the “Data Source” tab 716 from the KStore Administration main window 710 from FIG. 2. Refer to FIG. 12. FIG. 12 is a possible screen shot of the contents of KStore “Data Source” tab 830. To load data, the user selects the name/link “KLoad” 831.

A method for data Simulation has been described in patent application U.S. Serial No. ______, filed on Apr. 13, 2005 entitled, “Multiple stream data simulation adapted for a KStore” owned by the assignee of the present application.

Application Designer

The KStore Application Designer can be used to design and develop GUI applications that incorporate and associate the KStore analytics with the user's live data. In a single session, the user can design and test a KStore application, using live production data that has been loaded into KStore. Because of the unique data structure of KStore, no data corruption can occur. The user does not have to wait for runtime to see if the application worked as designed. Because the user is using live data, it is instantly obvious (as the application is built) if the analytics are working with the data as designed and the GUI design shows the data properly.

The Application Designer also provides a method and system for rapidly developing applications without having to understand how the code behind each KStore analytics works. Using simple drag and drop technology, the programmer can build applications that use the KStore analytics and other KStore tools that enable the programmer to build and define data constraints. The programmer needs to simply understand what each KStore analytic is pre-programmed to accomplish when it is associated with a field or group of fields; there is no need to actually understand the code behind the analytics.

To use this feature, the user may select the “Tools” tab 717 from the KStore Administration main window 710 FIG. 2. Refer again to FIG. 11. The contents of KStore “Tools” tab appears with the name/link “Application Designer” 824. The user may select this name/link to access KStore Application Designer.

KStore Application Designer has been described in patent application U.S. Ser. No. 11/150,063 filed Jun. 10, 2005, entitled, “KStore Application Designer.”

Those skilled in the art will appreciate that any number of such analytics can be conceived and implemented on various types of known data manipulation technologies. Furthermore, it will be understood that any analytic that can be conceived and implemented on known and future data manipulation technologies can be implemented on an interlocking trees datastore as well. In order to implement such analytics the skilled artisan can use the examples shown herein to illustrate the manner in which any other defined analytics can be implemented within interlocking trees datastore technology.

Thus, the number of different analytics that can be performed within interlocking trees datastores is limited only by the number of analytics that a user can conceive and implement. Just as the skilled artisan can develop and implement methods for performing desired analytics in known data structures according to the specifications of the data structures used, the skilled artisan can use the techniques for developing analytics demonstrated herein and any other techniques known to the skilled artisan to provide analytics.

APPENDIX

| Analytical | | |
|---|---|---|
| Functions | Statistical Functions | Financial Functions |
| Average | Standard Deviation | Accrued Interest |
| Mean | Standard Deviation of | Accrued Interest Maturity |
| Count | a Population | Amount Received at |
| Sum | Variance | Maturity |
| Maximum | Variance of a | Bond-equivalent Yield for |
| Minimum | Population | T-BILL |
| Median | Geometric Mean | Convert Dollar Price from |
| Mode | Average Deviation | Fraction to Decimal |
| Product | Kurtosis | Convert Dollar Price from |
| Rank | Skew | Decimal to Fraction |
| Percentile | Beta Distribution | Cumulative Interest Paid on |
| “N”-Tile | Beta Inverse | Loan |
| N-tile by Step | Binomial Distribution | Cumulative Principal Paid |
| N-tile by Value | Probability | on Loan |
| N-tile by Step and | Chi Distribution | Depreciation for each |
| Value | Chi Inverse | Accounting Period |
| Running Total | Confidence | Days In Coupon Period to |
| Running Standard | Correlation Coefficient | Settlement Date |
| Deviation | Covariance | Days In Coupon Period |
| Running Standard | Critical Binomial | with Settlement Date |
| Deviation of | Distribution | Days from Settlement Date |
| Population | Chi Test | to Next Coupon |
| Running | (Independence) | Double-Declining Balance |
| Minimum | | |
| Running | Cumulative Binomial | Method |
| Maximum | Distribution | Discount Rate For a |
| Running Count | Exponent Distribution | Security |
| Moving | F-Probability | Effective Annual Interest |
| Difference | | |
| Moving | Distribution | Rate |
| Maximum | | |
| Moving | F-Test | Fixed-Declining Balance |
| Minimum | | |
| Moving Average | Fisher Transformation | Method |
| Moving Sum | Gamma Distribution | Future Value |
| Moving Count | Gamma Inverse | Future Value of Initial |
| Moving Standard | Gamma Logarithm | Principal with Compound |
| Deviation | Homoscedastic Ttest | Interest Rates |
| Moving Standard | Heteroscedastic Ttest | Interest Rate |
| Deviation of | Hypergeometric | Interest Payment |
| Population | Distribution | Internal Rate of Return |
| Last Value in | Intercept Point | Interest Rate per Annuity |
| Range | Inverse of Lognormal | Macauley Duration |
| First Value in | Cumulative | Modified Duration |
| Range | Distribution | Modified Internal Rate of |
| Exponential | Inverse of F | Return |
| Weight Moving | Probability Distribution | Next Coupon Date After |
| Average | Inverse of Fisher | Settlement Date |
| Exponential | Inverse of the | Number of Coupons |
| Weight Running | Standard Normal | Between Settlement and |
| Average | Cumulative | Maturity Date |
| Absolute | Distribution | Nominal Annual Interest |
| A-cosine | Inverse of the T- | Rate |
| A-cosine | Distribution | Number of Investment |
| hyperbolic | Lognormal Cumulative | Periods |
| A-sine | Distribution | Net Present Value |
| A-sine hyperbolic | Mean T-Test | Odd First period Yield |
| A-tan | Negative Binomial | Odd Last Period |
| A-tan2 | Distribution | Previous Coupon Date |
| A-tan hyperbolic | Normal Cumulative | Before Settlement Date |
| Ceiling | Distribution | Price Per $100 Face Value |
| Combine | Normal Distribution | with Odd First Period0 |
| Cosine | Inverse | Payment |
| Cosine hyperbolic | Number of | Payment on Principal |
| Degrees | Permutations for a | Price |
| Exponent | Given Object | Price Discount |
| Factorial | Paired T-test | Price at Maturity |
| Floor | Poisson Distribution | Present Value |
| Int | (Predict Number of | Prorated Depreciation for |
| Ln | Events) | each Accounting Period |
| Log | Pearson Product | Straight Line Depreciation |
| Log10 | Moment Correlation | Sum-Of-Years' Digits |
| Mod | Coefficient | Depreciation |
| Power | RSQ (Square of | T-BILL Price |
| Quotient | Pearson) | T-BILL Yield |
| Radians | Slope of Linear | Variable Declining Balance |
| Randbetween | Regression | Yield |
| Round | STEYX (Standard | Yield for Discounted |
| Sine | Error of Predicted “y” | Security |
| Sine hyperbolic | Value) | Yield at Maturity |
| Square Root | Standardize | |
| Tan | Standard Normal | |
| Tan hyperbolic | Cumulative | |
| Truncate | Distribution | |
| | T-Distribution | |
| | Variance Test | |
| | Weibull Distribution | |
| | (Reliability Analysis) | |

| | |
|---|---|
| Standard Deviation | Stat |
| Variance | Stat |
| Geometric Mean | Stat |
| Average Deviation | Stat |
| Kurtosis | Stat |
| Skew | Stat |
| Beta Distribution | Stat |
| Beta Inverse | Stat |
| Binomial Distribution Probability | Stat |
| Chi Distribution | Stat |
| Chi Inverse | Stat |
| Chi Test (Independence) | Stat |
| Confidence | Stat |
| Correlation Coefficient | Stat |
| Covariance | Stat |
| Critical Binomial Distribution | Stat |
| Cumulative Binomial Distribution | Stat |
| Exponent Distribution | Stat |
| F-Probability Distribution | Stat |
| F-Test | Stat |
| Fisher Transformation | Stat |
| Gamma Transformation | |
| Gamma Inverse | Stat |
| Multi-variate Regression | |
| Homoscedastic t-Test | |
| Heteroscedastic t-Test | |
| Hypergeometric Distribution | |
| Intercept Point | Stat |
| Inverse of Lognormal | Stat |
| Cumulative Distribution | |
| Inverse of Lognormal | dup |
| Linear Regression | |
| Inverse of F Probability | Stat |
| Distribution Inverse of Fisher | |
| Inverse of the Std Normal | Stat |
| Inverse of the t-Distribution | Stat |
| Variance Test | Stat |
| Lognormal Cumulative Distr. | Stat |
| Mean t-Test | Stat |
| Negative Binomial Distribution | Stat |
| Normal Cumulative Distribution | Stat |
| Normal Distribution Inverse | Stat |
| Number of Permutations | Stat |
| Paired t-Test | Stat |
| Poisson Distribution | Stat |
| Pearson Product Moment | Stat |
| Correlation Coefficient | Stat |
| R Squared (Square of Pearson) | Stat |
| Slope of Linear Regression | Stat |
| STEYX | Stat |
| Standardize | Stat |
| Std Normal Cum Distribution | Stat |
| t-Distribution | Stat |

Regression

| | | |
|---|---|---|
| [symbol] Conditional Logit | [symbol] Least Squares | [symbol] Moore-Penrose Matrix |
| Regr. . . | Fitting-. . . | I. . . |
| [symbol] Correlation | [symbol] Least Squares | [symbol] Multiple Regression |
| Fitting-. . . | | |
| [symbol] Correlation Coefficient | [symbol] Least Squares | [symbol] Nonlinear Least |
| | Fitting-. . . | Square. . . |
| [symbol] Correlation | [symbol] Least Squares | [symbol] Normal Equation |
| Coefficien. . . | Fitting-. . . | |
| [symbol] Correlation Index | [symbol] Linear Regression | [symbol] Probability Paper |
| [symbol] Correlation Ratio | [symbol] Loess Local | [symbol] Pseudoinverse |
| | Regression | |
| [symbol] Figure-of-Merit Function | [symbol] Logistic Regression | [symbol] Regression |
| [symbol] Gasser-Müller Technique | [symbol] Matrix 1-Inverse | [symbol] Regression Coefficient |
| [symbol] Least Squares Fitting | [symbol] Merit Function | [symbol] Residual |
| [symbol] Least Squares Fitting-. . . | [symbol] Minimax Polynomial | [symbol] Statistical Correlation |

| | | Sub- | |
|---|---|---|---|
| Descriptive Stats | Category | category | Source |
| Arithmetic mean | | | |
| 95% confidence limit for mean | | | |
| 99% confidence limit for mean | | | |
| Angular Descriptive Stats | | | |
| Angular deviation | | | |
| Angular variance | | | |
| Average deviation | | | |
| Circular standard deviation | | | |
| Circular variance | | | |
| Cosine mean | | | |
| Geometric mean | | | |
| Kurtosis | | | |
| Max value | | | |
| Mean angle | | | |
| Mean angle Cosine | | | |
| Mean angle Sine | | | |
| Mean angle Tan | | | |
| Mean vector length | | | |
| Median | | | |
| Min value | | | |
| Number of samples | | | |
| Sample range | | | |
| Sine Mean | | | |
| Skewness | | | |
| Standard deviation (n) | | | |
| Standard deviation (n − 1) | | | |
| Standard error | | | |
| Sx | | | |
| Sx2 | | | |
| Variance | | | |

Descriptive
Statistics

| | | |
|---|---|---|
| [symbol] Absolute Frequency | [symbol] Fisher Information | [symbol] Quantile |
| | Matrix | |
| [symbol] Adjacent Value | [symbol] Frequency Distribution | [symbol] Quartile |
| [symbol] Almost Surely | [symbol] Frequency Polygon | [symbol] Quartile Deviation |
| [symbol] Batch | [symbol] Full Width at Half | [symbol] Quartile Variation |
| | Max. . . | Coe. . . |
| [symbol] Benford's Law | [symbol] Gauss's Inequality | [symbol] Record Setting |
| [symbol] Bimodal | [symbol] H-Spread | [symbol] Regression to the |
| | | Mean |
| [symbol] Bimodal Distribution | [symbol] High-Water Mark | [symbol] Relative Cumulative |
| | | Fr. . . |
| [symbol] Bin | [symbol] Hinge | [symbol] Relative Frequency |
| [symbol] Bowley Skewness | [symbol] Indicator | [symbol] Reversion to the Mean |
| [symbol] Clarity | [symbol] Interquartile Range | [symbol] Running Maximum |
| [symbol] Class | [symbol] Mean Absolute Deviation | [symbol] Signed Deviation |
| [symbol] Class Boundaries | [symbol] Mesokurtic | [symbol] Statistical Depth |
| [symbol] Class Interval | [symbol] Midrange | [symbol] Statistical Dispersion |
| [symbol] Class Limits | [symbol] Mode | [symbol] Statistical Median |
| [symbol] Class Mark | [symbol] Multimodal | [symbol] Statistical Range |
| [symbol] Cumulative Frequency | [symbol] Outlier | [symbol] Step |
| [symbol] Factor Level | [symbol] Percentile | [symbol] Trimodal |
| [symbol] Far Out | [symbol] Percentile Rank | [symbol] I-Statistic |
| [symbol] Fence | [symbol] Plotting Position | [symbol] Unimodal |
| [symbol] Fisher Information | [symbol] Population | [symbol] Zipf's Law |

Source 6

| | | Sub- | |
|---|---|---|---|
| Data Transforms | Category | Category | Source |
| Polynomial | | | |
| Absolute Value | Math | | |
| aCos | Math | | |
| Add columns | Math | | |
| aSin | Math | | |
| aTan | Math | | |
| Bessel functions of first and | | | |
| second kind | | | |
| Center | | | |
| Chi-Squared probabilities | | | |
| Complementary error function | | | |
| Conversions | | | |
| Cos | Math | | |
| Cosh | Math | | |
| Cube Root | Math | | |
| Divide columns | Math | | |
| Error function | | | |
| Exp(x) | Math | | |
| F distribution probabilities | Stat | | |
| Integer ceiling, floor | Math | | |
| Ln(x + 1) | Math | | |
| Log10 | Math | | |
| Log2 | Math | | |
| Logit | Math | | |
| Matrix operations: inverse matrix, | | | |
| transpose | | | |
| Matrix | | | |
| Modulo | | | |
| Multiply columns | | | |
| Natural Log | | | |
| Normal probabilites | | | |
| Normit | | | |
| Powerful language to program | | | |
| user-defined | | | |
| transforms | | | |
| Probit | | | |
| Rank Ascending | Math | | |
| Rank Descending | Math | | |
| Reciprocal | | | |
| Sin | Math | | |
| Sinh | Math | | |
| Sort Ascending | | | |
| Sort Descending | | | |
| Square Root | | | |
| Standardize | | | |
| Student's t probabilities | | | |
| Subtract columns | | | |
| Tan | Math | | |
| Tanh | Math | | |
| Transform by a spreadsheet formula | | | |
| Xn | | | |

| | | Sub- | |
|---|---|---|---|
| Parametric Tests | Category | Category | Source |
| 2k factorial design for k = 2, 3 | Statistical | Parametric | |
| Angular-angular correlation | Statistical | Parametric | |
| Angular-linear correlation | Statistical | Parametric | |
| Backward elimination for | Statistical | Parametric | |
| multiple linear regression | | | |
| Bartlett's test | Statistical | Parametric | |
| Bonferroni t-test | Statistical | Parametric | |
| Chi-square test for | Statistical | Parametric | |
| compatibility of K counts | | | |
| Chi-square test for | Statistical | Parametric | |
| consistency in a 2 × k table | | | |
| Chi-square test for | Statistical | Parametric | |
| independence in a p × q table | | | |
| Cochran test for consistency | Statistical | Parametric | |
| in an n × k table of | | | |
| dichotomous data. | | | |
| Cochran test for variance | Statistical | Parametric | |
| outliers | | | |
| Compare 2 sample | Statistical | Parametric | |
| proportions | | | |
| Compare paired proportions | Statistical | Parametric | |
| Compare sample and | Statistical | Parametric | |
| population | | | |
| Compare two observed values | Statistical | Parametric | |
| Dixon test for outliers | Statistical | Parametric | |
| Duncan's test | Statistical | Parametric | |
| Dunnett's test | Statistical | Parametric | |
| Durbin-Watson test (residual | Statistical | Parametric | |
| auto correlation test) | | | |
| Fisher cumulant test for | Statistical | Parametric | |
| normality of a distribution. | | | |
| Frequency analysis | Statistical | Parametric | |
| F-test for K population means | Statistical | Parametric | |
| (ANOVA) | | | |
| F-test for multiple | Statistical | Parametric | |
| comparisons of contrasts | | | |
| between K population means | | | |
| F-test for the overall mean of | Statistical | Parametric | |
| K subpopulations (ANOVA) | | | |
| F-test for two population | Statistical | Parametric | |
| variances | | | |
| General N factor ANOVA for | Statistical | Parametric | |
| multiple fixed effects factors | | | |
| Harrison-Kanji-Gadsden test | Statistical | Parametric | |
| Hartley's test for equality of K | Statistical | Parametric | |
| variances | | | |
| Hotelling's T-square test for | Statistical | Parametric | |
| two series of population | | | |
| means | | | |
| Linear regression | Statistical | Parametric | |
| Linear-linear correlation | Statistical | Parametric | |
| Link-Wallace test for multiple | Statistical | Parametric | |
| com-parisons of k population | | | |
| means | | | |
| Mardia-Watson-Wheeler test | Statistical | Parametric | |
| (to test whether two | | | |
| independent random samples | | | |
| from circular observations | | | |
| differ significantly from each | | | |
| other regarding mean angle, | | | |
| angular variance or both) | | | |
| Multiple linear regression | Statistical | Parametric | |
| One-way non-repeated | Statistical | Parametric | |
| ANOVA | | | |
| One-way repeated ANOVA | Statistical | Parametric | |
| Paired t-test | Statistical | Parametric | |
| Pearson R | Statistical | Parametric | |
| Polynomial regression. | Statistical | Parametric | |
| Rayleigh test determine if | Statistical | Parametric | |
| oberved samples of angular | | | |
| data have a tendency to | | | |
| cluster around a given angle | | | |
| indicating a lack of | | | |
| randomness of the | | | |
| distribution) | | | |
| Repeated measures linear | Statistical | Parametric | |
| regression | | | |
| Sign test for a median | Statistical | Parametric | |
| Sign test for two medians | Statistical | Parametric | |
| (paired observations) | | | |
| Signed rank test for a mean | Statistical | Parametric | |
| Signed rank test for two | Statistical | Parametric | |
| mean (paired observations) | | | |
| Single classification ANCOVA | Statistical | Parametric | |
| for completely randomized | | | |
| design | | | |
| Single Factor analysis of | Statistical | Parametric | |
| variance for angular data | | | |
| The w/s test for normality of | Statistical | Parametric | |
| a population | | | |
| Three-way ANOVA | Statistical | Parametric | |
| Tigonometric regression. | Statistical | Parametric | |
| t-test of a correlation | Statistical | Parametric | |
| coefficient | | | |
| Tukey's test | Statistical | Parametric | |
| Two-way repeated ANOVA | Statistical | Parametric | |
| Two-way replicated ANOVA | Statistical | Parametric | |
| Unequal variance t-test | Statistical | Parametric | |
| Unpaired t-test | Statistical | Parametric | |
| Z-test for correlated | Statistical | Parametric | |
| proportions | | | |
| Z-test of 2 correlation | Statistical | Parametric | |
| coefficients | | | |
| Z-test of a correlation | Statistical | Parametric | |
| coefficient | | | |
| Independent t-test | Statistical | Parametric | |
| Dependent | Statistical | Parametric | |
| (paired or | | | |
| repeated | | | |
| measures) t- | | | |
| test | | | |
| ANOVA (use | Statistical | Parametric | |
| posthoc tests | | | |
| to compare | | | |
| group means) | | | |

| Nonparametric Tests | | |
|---|---|---|
| 2 × 2 Chi-squared | Stat | Nonparametric |
| Adjacency test for randomness of | Stat | Nonparametric |
| fluctuations | | |
| Angular-angular correlation | Stat | Nonparametric |
| Bowker test for nominal-scale data | Stat | Nonparametric |
| Chi-square test for k independent | Stat | Nonparametric |
| samples | | |
| Cochran Q-test. | Stat | Nonparametric |
| Contingency coefficient | Stat | Nonparametric |
| Cox's F-test | Stat | Nonparametric |
| Cramer coefficient C | Stat | Nonparametric |
| Cramer's V | Stat | Nonparametric |
| Extension of the median test | Stat | Nonparametric |
| Fisher contingency table test for | Stat | Nonparametric |
| variables with more than two | | |
| categories | | |
| Fisher-Pitman randomization test for | Stat | Nonparametric |
| interval-scale data | | |
| Fisher's cumulant test for normality of | Stat | Nonparametric |
| a distribution. | | |
| Fisher's exact test | Stat | Nonparametric |
| Friedmann's test | Stat | Nonparametric |
| Friedmann's test for multiple treatment | Stat | Nonparametric |
| of a series of subjects | | |
| F-test for two counts (Poisson | Stat | Nonparametric |
| distribution). | | |
| Gamma statistic for ordered variables | Stat | Nonparametric |
| Gehan test for censored data | Stat | Nonparametric |
| Jonckheere test for ordered | Stat | Nonparametric |
| alternatives | | |
| Kappa statistic for nominally scaled | Stat | Nonparametric |
| data. | | |
| Kendall coefficient of agreement u | Stat | Nonparametric |
| Kendall coefficient of concordance | Stat | Nonparametric |
| Kendall partial rank correlation | Stat | Nonparametric |
| Kendall rank correlation | Stat | Nonparametric |
| Kolmogorov-Smirnov test | Stat | Nonparametric |
| Kruskal-Wallis test | Stat | Nonparametric |
| Lambda statistic for asymmetrical | Stat | Nonparametric |
| association | | |
| Lehmacher test for variables with more | Stat | Nonparametric |
| than 2 categories | | |
| LogRank test | Stat | Nonparametric |
| Mann-Whitney U-Test | Stat | Nonparametric |
| Mantel-Haenszel test | Stat | Nonparametric |
| McNemar's test | Stat | Nonparametric |
| Median test | Stat | Nonparametric |
| Median test of k populations | Stat | Nonparametric |
| Median test of two populations | Stat | Nonparametric |
| Moses rank-like test for scale | Stat | Nonparametric |
| differences. | | |
| N × K Chi-squared | Stat | Nonparametric |
| One-sample chi-squared | Stat | Nonparametric |
| Page test for ordered alternatives | Stat | Nonparametric |
| Phi-coefficient for 2 × 2 tables | Stat | Nonparametric |
| Pitman randomization test for interval | Stat | Nonparametric |
| scale data | | |
| Pitman-Welch test for interval scale | Stat | Nonparametric |
| data | | |
| Rank correlation test for agreement in | Stat | Nonparametric |
| multiple judgements | | |
| Robust rank order test | Stat | Nonparametric |
| Run-test for randomness in a sample | Stat | Nonparametric |
| Run-test for randomness of two | Stat | Nonparametric |
| related samples | | |
| Run-test on successive differences for | Stat | Nonparametric |
| randomness in a sample | | |
| Sequential test for a population mean | Stat | Nonparametric |
| Sequential test for a standard | Stat | Nonparametric |
| deviation | | |
| Serial correlation test for randomness | Stat | Nonparametric |
| of fluctuations | | |
| Siegel-Tukey test for scale differences | Stat | Nonparametric |
| Somers d for asymmetrical association | Stat | Nonparametric |
| of ordered variables | | |
| Spearman rank correlation | Stat | Nonparametric |
| Steel test for comparing K treatments | Stat | Nonparametric |
| with a control | | |
| Test the equality of multinomial | Stat | Nonparametric |
| distributions | | |
| The difference sign test for | Stat | Nonparametric |
| randomness in a sample | | |
| The Siegal-Tukey rank sum dispersion | Stat | Nonparametric |
| test of two variances | | |
| Turning point test for randomness of | Stat | Nonparametric |
| fluctuations | | |
| Wall test for nominal scale data | Stat | Nonparametric |
| Watson U2 test (To test whether two | Stat | Nonparametric |
| samples from circular observations | | |
| differ significantly from each other, | | |
| regarding mean direction or angular | | |
| variance | | |
| Watson-Williams test (to test whether | Stat | Nonparametric |
| the mean angles of two independent | | |
| circular observations differ significantly | | |
| from each other) | | |
| Wilcoxon inversion (U) test | Stat | Nonparametric |
| Wilcoxon-Mann-Whitney rank sum test | Stat | Nonparametric |
| for randomness of signs | | |
| Wilcoxon's matched pairs | Stat | Nonparametric |
| Sign Test | Stat | Nonparametric |

| Graphics | Category | SubCategory | Source |
|---|---|---|---|
| Pie chart | | | |
| Bar chart | | | |
| Area graph | | | |
| Line graph | | | |
| Scatter graph | | | |
| Box-whisker graph | | | |
| 3D surface graph | | | |
| Bubble charts | | | |
| Polar charts | | | |
| Radar charts | | | |
| Polynomial regression plot | | | |
| Pareto chart option in frequency | | | |
| analysis plots | | | |
| Kaplan-Meier survival curves | | | |
| Density function plots and cumulative | | | |
| probability plots for Gaussian | | | |
| (Normal) distribution, lognormal | | | |
| distribution, Weibull distribution, | | | |
| gamma distribution, Poisson | | | |
| distribution, beta distribution and | | | |
| chi-square | | | |
| distribution | | | |
| Regression plots direct from raw data | | | |
| (single factor, single factor repeated | | | |
| measures) | | | |
| Polynomial regression plots | | | |
| One-factor response curves and | | | |
| two-factor response surface | | | |
| plots(1st and 2nd order) | | | |
| Minimum spanning tree plots for 2 | | | |
| dimensions | | | |
| Levey-Jennings/Shewart Charts | | | |
| Sequential test for a population mean | | | |
| Sequential test for a standard | | | |
| deviation | | | |
| classification | | | |
| c-chart | | | |
| X-chart | | | |
| R-chart | | | |
| Bihistogram | Graph | Stat | 13, 14 |
| Box-andWhisker Plot or Box Plot | Graph | Stat | 13 |
| Chernoff Face | Graph | | 13, 15 |
| Cumulative Frequency Polygon | Graph | | 13 |
| Frequency Curve | Graph | | 13 |
| Histogram | Graph | | 13 |
| Letter-Value Display (incl Hinges) | Graph | | 13 |
| Ogive | Graph | | 13 |
| Outlier | Graph | | 13 |
| Pareto Plot | Graph | | 13 |
| Quantile-quantile or q-q Plot | Graph | | 13 |
| Stem-and_leaf diagram | Graph | | 13 |

Quality Control
The sequential test for a dichotomous classification
Quality control acceptance sampling
   Miscellaneous
Generate uniformly distributed random numbers
Generate normal randomly distributed numbers
Generate Poisson randomly distributed numbers
Generate exponentially distributed numbers
Generate gamma randomly distributed numbers
Fill range with arithmetic sequence
Fill range with geometric sequence
Fill range with constant
Kolmogorov-Smirnoff test for goodness of fit (to investigate the difference between an observed distribution and a specified population distribution)
   Categorical-3
Contingency Table
Confidence Interval for a Proportion
Confidence Interval for the Difference Between Two Proportions
Expected Frequencies
Observed Frequencies
Chi-Squared Goodness of Fit Test
Chi-Squared Test of Association
Chi-Squared Test of Homogeneity
   Source-5
   ANOVA, Bonferroni Correction, Chi-Squared Test, Fisher's Exact Test, Fisher Sign Test, Kolmogorov-Smirnov Test, Likelihood Ratio, Log Likelihood Procedure, MANOVA, Negative Likelihood Ratio, Paired t-Test, Parametric Test, Predictive Value, Sensitivity, Significance Test, Specificity, Type I Error, Type II Error, Wilcoxon Rank Sum Test, Wilcoxon Signed Rank Test.
   Reporting
   Error Analysis

Absolute Error

Accuracy

Arbitrary Precision j

Confidence Interval

Confidence Limits

Deviation

Equiripple

Error

Error Propagation

Estimate

Fixed Precision

Margin of Error

Minimax Approximation

Outlier

Percentage Error

Precision

Relative Error

Significance Arithmetic

Significant Digits

Source 7

Estimator

S

Biased Estimator

Estimator

Estimator Bias

Expectation Value

Fisher's Estimator Ine . . .

h-Statistic

k-Statistic

L-Estimate

M-Estimate

Maximum Likelihood

Maximum Likelihood Est . . .

Maximum Likelihood Method

Point Estimator

Polyache

Polykay

R-Estimate

Robust Estimator

Sample Central Moment

Sample Mean

Sample Variance

Unbiased Estimator

Wald's Equation

Source 8

Markov Processes

Chapman-Kolmogorov Equ . . .

Markoff Chain

Markov Chain

Markov Process

Markov Sequence

Smith's Markov Process . . .

Stochastic Matrix

Source 9

Moments

Absolute Deviation

Absolute Moment

Average Absolute Devia . . .

Berry-Esséen Theorem

Bessel's Correction

Bessel's Formulas

Central Moment

Characteristic Function

CharlierCheck

Covariance

Cumulant

Cumulan-Generating Fu . . .

Excess

Factorial Moment

Gamma Statistic

h-Statistic

Heteroscedastic

Homoscedastic

k-Statistic

Kendall Operator

Kurtosis

L-Moment

Leptokurtic

Mean

Mean Deviation

Mesokurtic

Moment

Moment-Generating Func . . .

Moment Problem

Moment Sequence

Momental Skewness

Pearson Mode Skewness

Pearson's Skewness Coe . . .

Polyache

Polykay

Population Mean

Population Variance

Raw Moment

Relative Deviation

Robbin's Inequality

Root-Mean-Square

Sample Central Moment

Sample Mean

Sample Raw Moment

Sample Variance

Sample Variance Comput . . .

Sample Variance Distri . . .

Sheppard's Correction

Skewness

Standard Deviation

Standard Deviation Dis . . .

Standard Error

Standard Unit

Standardized Moment

Variance

Variation Coefficient

Source 10

Multivariate

Statistics

Bagging

Bivariate

Bivariate Normal Distr . . .

Boosting

Cluster Analysis

Discriminant Analysis

FindClusters

Kendall Operator

Multinormal Distribution

Multivariate

Multivariate Normal Di . . .

Principal Component An . . .

Trivariate Normal Dist . . .

Univariate

Wishart Distribution

Source 11

Functions

Absolute Value

Absolutely Monotonic F . . .

Additive Function

Almost Periodic Function

Antiperiodic Function

Arithmetic Function

Bilinear Function

Borsuk-Ulam Theorem

Closed Map

Codomain

Complete Biothogonal . . .

Complete Convex Function

Complete Orthogonal Sy . . .

Complete Set of Functions

Completely Monotonic F . . .

Completely Multiplicat . . .

Complex Map

Complex Modulus

Complex Variable

Constant Map

Decreasing Function

Domain

Doubly Periodic Function

Elementary Function

Euler's Homogeneous Fun . . .

Even Function

Exponentially Decreasi . . .

Exponentially Increasi . . .

Function

Function Centroid

Function Convex Hull

Function Space

Function Value

Fundamental Theorem of . . .

Gram-Schmidt Orthonorm . . .

Hamburger Moment Problem

Homogeneous Function

Image

Implicit Function

Inverse Function

Inverse Function Theorem

Jensen's Theorem

Kepler's Equation

Lacunary Function

Least Period

Linear Function

Linearly Dependent Fun . . .

Liouville's Principle

Lipschitz Function

Logarithmically Concav . . .

Logarithmically Convex . . .

Logarithmically Decrea . . .

Logarithmically Increa . . .

Many-to-One

Map

Map Germ

Map Orbit

Masser-Gramain Constant

Möbius Periodic Function

Monotone Function

Multilinear

Multiple-Valued Function

Multiplicative Function

Multivalued Function

Multivariate Function

Natural Boundary

Natural Domain

Negative Part

Nested Function

Normal Function

Numerica Function

Odd Function

Operation

Orthogonal Fucntions

Orthonormal Functions

Oscillating Function

Oscillation

Particularly Well-Beha . . .

Plurisubharmonic Function

Positive Definite Func . . .

Positive Part

Pringheim's Theorem

Range

Real Analytic Function

Real Function

Real Variable

Rectifiable Set

Reflection Relation

Regular Sequence

Riemann's Moduli Problem

Riemann's Moduli Space

Rodrigues Representation

Saltus

Scalar Function

Scalar-Valued Function

Schwartz Function

Schwartz Space

Schwartz's Inequality

Semianalytic

Sharkovsky's Theorem

Single-Valued Function

Singleton Function

Singly Periodic Function

Smooth Function

Special Function

Surjection

Symmetric Function

Totally Multiplicative . . .

Transcendental Equation

Transcendental Function

Triply Periodic Function

Unary Operation

Univalent Function

Univariate Function

Unknown

Value

Variable

Implicit Function Theorem

Increasing Function

Injection

Integer Function

Path Trace

Period

Periodic Function

Periodic Point

Weighting Function

Zero Map

Source 12

Web Sites

1—http://www.microstrategy.com/QuickTours/HTML/MSTR7/content7.htm

2—http://www.cas.lancs.ac.uk/glossary_v1.1/nonparam.html#nonparat

3—http://www.cas.lancs.ac.uk/glossary_v1.1/catdat.html#chigof

4—http://staff.washington.edu/bskiver/ratlab/stats-notes.html

5—http://mathworld.wolfram.com/StatisticalTest.html

6—http://mathworld.wolfram.com/topics/DescriptiveStatistics.html

7—http://mathworld.wolfram.com/topics/ErrorAnalysis.html

8—http://mathworld.wolfram.com/topics/Estimators.html

9—http://mathworld.wolfram.com/topics/MarkovProcesses.html

10—http://mathworld.wolfram.com/topics/Moments.html

11—http://mathworld.wolfram.com/topics/MultivariateStatistics.html

12—http://mathworld.wolfram.com/topics/Functions.html

13—http://mathworld.wolfram.com/topics/StatisticalPlots.html

14—http://www.itl.nist.gov/div898/handbook/eda/section3/bihistog.htm

15—http://www.halfbakery.com/idea/chernoff_{—}20face_{—}20stock_{—}20screens

16—

What is claimed is:

1. A data analysis system for performing an analytic to obtain an analytic result in a computing device having memory associated therewith, said data analysis system comprising:
a data analyzer interface,
at least one interlocking trees datastore within said associated memory of said computing device, and
at least one analytic application executed by said computing device.

2. The data analysis system of claim 1, further comprising a plurality of interlocking trees datastores wherein said at least one interlocking trees datastore is selected from said plurality of interlocking trees datastores in accordance with said data analyzer interface.

3. The data analysis system of claim 1, further comprising a plurality of data sources wherein said at least one interlocking trees datastore is created from a data source selected from said plurality of data sources in accordance with said data analyzer interface.

4. The data analysis system of claim 1, wherein said at least one interlocking trees datastore further comprises a static interlocking trees datastore.

5. The data analysis system of claim 1, wherein said at least one interlocking trees datastore comprises a dynamic interlocking trees datastore.

6. The data analysis system of claim 5, wherein said at least one interlocking trees datastore continuously records new data.

7. The data analysis system of claim 5, wherein said at least one interlocking trees datastore includes records of data and said at least one interlocking trees datastore continuously receives updates of said records of data.

8. The data analysis system of claim 1, including a plurality of analytic applications wherein said at least one analytic application is selected from said plurality of analytic applications in accordance with said data analyzer interface.

9. The data analysis system of claim 8, wherein said at least one analytic application analyzes a static interlocking trees datastore.

10. The data analysis system of claim 8, wherein said at least one analytic application analyzes a dynamic interlocking trees datastore.

11. The data analysis system of claim 8, wherein said at least one analytic application further comprises any type of analytic.

12. The data analysis system of claim 11, wherein said at least one analytic application further comprises an accounting/mathematical functional category analytic.

13. The data analysis system of claim 12, wherein said at least one analytic application further comprises a sum analytic.

14. The data analysis system of claim 11, wherein said at least one analytic application further comprises a statistical functional category analytic.

15. The data analysis system of claim 11, wherein said at least one analytic application further comprises a classification functional category analytic.

16. The data analysis system of claim 11, wherein said at least one analytic application further comprises a relationship functional category analytic.

17. The data analysis system of claim 11, wherein said at least one analytic application further comprises a visualization functional category analytic.

18. The data analysis system of claim 11, wherein said at least one analytic application further comprises a statistical functional category analytic.

19. The data analysis system of claim 11, wherein said at least one analytic application further comprises a meta-data functional category analytic.

20. The data analysis system of claim 12, wherein said at least one analytic application comprises a further functional category analytic.

21. The data analysis system of claim 1, wherein said data analyzer interface provides access to at least one administration application.

22. A data analysis method for performing an analytic to obtain an analytic result in a data processing device having a memory associated therewith, said method comprising:
providing a data analyzer interface for said data processing device,
storing at least one interlocking trees datastore in said memory of said data processing device, and
executing at least one analytic application in accordance with said at least one interlocking trees datastore.

23. The data analysis method of claim 22, wherein said associated memory of said data processing device includes a plurality of interlocking trees datastores further comprising selecting said at least one interlocking trees datastore from said plurality of interlocking trees datastores in accordance with said data analyzer interface.

24. The data analysis method of claim 22, wherein said data processing device includes a plurality of data sources further comprising creating said at least one interlocking trees datastore from a data source selected from said plurality of data sources in accordance with said data analyzer interface.

25. The data analysis method of claim 22, wherein said data processing device includes a plurality of analytic applications further comprising selecting said at least one analytic application from said plurality of analytic applications in accordance with said data analyzer interface.

26. A method of performing an analytic to obtain an analytic result in a KStore having a plurality of K paths each K path of said plurality of K paths having end nodes, comprising:
determining at least one KStore parameter in accordance with at least one K path of said plurality of K paths to provide at least one determined parameter; and
obtaining said analytic result in accordance with said determined at least one determined parameter.

27. The method of performing an analytic to obtain an analytic result of claim 26, wherein said at least one KStore result comprises a count.

28. The method of performing an analytic to obtain an analytic result of claim 26, wherein said at least one KStore result comprises a value.

29. The method of performing an analytic to obtain an analytic result of claim 26, wherein said at least one KStore result comprises sequence information.

30. The method of performing an analytic to obtain an analytic result of claim 26, comprising constraining said KStore with at least one constraint to provide at least one selected K path from said plurality of K paths.

31. The method of performing an analytic to obtain an analytic result of claim 30, wherein said constraining provides a set of selected K paths comprising applying at least one focus to said KStore to provide a further set of selected K paths.

32. The method of performing an analytic to obtain an analytic result of claim 26, wherein said analytic is an analytic for analyzing a dynamic KStore.

33. The method of performing an analytic to obtain an analytic result of claim 26, wherein said analytic comprises an accounting/mathematical functional category analytic.

34. The method of performing an analytic to obtain an analytic result of claim 33, wherein said analytic is a sum analytic and said analytic result comprises a sum of a plurality of parameters.

35. The method of performing an analytic to obtain an analytic result of claim 34, a set of selected K paths further comprising:
constraining said KStore to provide a set of selected K paths;
determining a plurality of said KStore results in accordance with said set of selected K paths; and
summing said KStore parameters of said plurality of KStore parameters.

36. The method of performing an analytic to obtain an analytic result of claim 35, further comprising traversing said K paths of said set of K paths to determine said plurality of KStore parameters.

37. The method of performing an analytic to obtain an analytic result of claim 36, further comprising:
traversing said K paths of said set of K paths to the respective end nodes of said K paths of said set of selected K paths; and
determining said plurality of KStore parameters in accordance with said respective end nodes.

38. The method of performing an analytic to obtain an analytic result of claim 37, further comprising:
determining a count of each K path of said set of K paths to provide a plurality of determined counts; and
summing said determined counts to provide said analytic result.

39. The method of performing an analytic to obtain an analytic result of claim 33, wherein said analytic is a distinct count analytic and said analytic result is a count of at least one distinct parameter in said KStore.

40. The method of performing an analytic to obtain an analytic result of claim 39, further comprising:
constraining said KStore to provide a set of selected K paths;
determining the number of times said distinct parameter occurs within said set of K paths.

41. The method of performing an analytic to obtain an analytic result of claim 40, further comprising:
determining a plurality of distinct parameters; and
determining the number of times each distinct value of said plurality of distinct parameters occurs within said set of K paths.

42. The method of performing an analytic to obtain an analytic result of claim 41, further comprising:
performing distinct parameter traversals of said K paths of said set of K paths; and
determining said number of times said distinct parameters are encountered in accordance with said distinct value traversals.

43. The method of performing an analytic to obtain an analytic result of claim 40, further comprising applying a further constraint to said KStore prior to determine said number of times said distinct value occurs.

44. The method of performing an analytic to obtain an analytic result of claim 40, further comprising applying a focus variable to said KStore prior to determining said number of times said distinct parameter occurs.

45. The method of performing an analytic to obtain an analytic result of claim 33, wherein said analytic comprises a data aggregation analytic and said analytic result is aggregated data.

46. The method of performing an analytic to obtain an analytic result of claim 33, wherein said analytic comprises the accounting/mathematical functional category analytics other than those in the group consisting of the sum analytic, the distinct group analytic and the aggregated data analytic.

47. The method of performing an analytic to obtain an analytic result of claim 46, further comprising:
constraining said KStore to provide a set of selected K paths; and
traversing at least one K path of said set of selected K paths.

48. The method of performing an analytic to obtain an analytic result of claim 26, wherein said analytic comprises a statistical functional category of analytics.

49. The method of performing an analytic to obtain an analytic result of claim 48, wherein said analytic comprises a single variable prediction analytic.

50. The method of performing an analytic to obtain an analytic result of claim 49, further comprising:
applying a focus variable to said KStore; and
determining a probability in accordance with said focus variable.

51. The method of performing an analytic to obtain an analytic result of claim 50, further comprising:
constraining said KStore to provide a set of selected K paths; and
determining a distinct count of said focus variable within said set of selected K paths.

52. The method of performing an analytic to obtain an analytic result of claim 51, further comprising determining said probability in accordance with the number of selected K paths in said set of selected K paths.

53. The method of performing an analytic to obtain an analytic result of claim 51, further comprising determining said probability in accordance with the number of K paths in said plurality of selected K paths.

54. The method of performing an analytic to obtain an analytic result of claim 51, wherein said determining of said distinct count further comprises:
performing distinct count traversals of said K paths of set of selected K paths; and
counting the number of times said focus variable is encountered during said distinct count traversals.

55. The method of performing an analytic to obtain an analytic result of claim 48, wherein said analytic comprises all further statistical functional category analytics other than those in the group consisting of the single variable prediction analytic.

56. The method of performing an analytic to obtain an analytic result of claim 55, further comprising:
constraining said KStore to provide a set of selected K paths;
traversing at least one K path of said set of selected K paths.

57. The method of performing an analytic to obtain an analytic result of claim 26, wherein said analytic comprises a classificational functional category analytic.

58. The method of performing an analytic to obtain an analytic result of claim 57, wherein said analytic is a contented classification analytic and said analytic result is a classification of a sample within a context.

59. The method of performing an analytic to obtain an analytic result of claim 58, wherein the sample contains sample variables comprising constraining said KStore with said sample variables.

60. The method of performing an analytic to obtain an analytic result of claim 57, wherein said analytic is a dynamic decision free analytic with said analytic result is a hierarchical tree representation of a data set.

61. The method of performing an analytic to obtain an analytic result of claim 60, wherein said hierarchical tree representation comprises a single root node and a plurality of branches beginning with said single root node.

62. The method of performing an analytic to obtain an analytic result of claim 57, wherein said analytic comprises a Bayes classification analytic and said analytic result is a probability.

63. The method of performing an analytic to obtain an analytic resultof claim 62, wherein said analytic result comprises a probabilistic classification.

64. The method of performing an analytic to obtain an analytic result of claim 26, wherein said analytic comprises a relationship functional category analytic.

65. The method of performing an analytic to obtain an analytic result of claim 64, wherein said analytic comprises an associated rules category analytic and said analytic result is a probability.

66. The method of performing an analytic to obtain an analytic result of claim 65, wherein said probability comprises a probability of a variable co-occurring with a focus variable.

67. The method of performing an analytic to obtain an analytic result of claim 66, wherein said analytic is a market basket analytic and an analytic result is a list of items that are frequently grouped together.

68. The method of performing an analytic to obtain an analytic result of claim 67, comprising determining said list of items in accordance with a list of sales transactions.

69. The method of performing an analytic to obtain an analytic result of claim 26, wherein said analytic comprises a visualizational category analytic.

70. The method of performing an analytic to obtain an analytic result of claim 69, wherein said analytic comprises a chart generator analytic.

71. The method of performing an analytic to obtain an analytic result of claim 69, wherein said analytic comprises a field chart analytic.

72. The method of performing an analytic to obtain an analytic result of claim 26, wherein said analytic comprises a meta-data functional category analytic.

73. The method of performing an analytic to obtain an analytic result of claim 26, wherein said analytic comprises all further analytics in categories other than the accounting/mathematical functional category, the statistical functional category, the classification functional category, the relationship functional category, the visualization functional category and the meta-data functional category.

74. A KStore system for performing an analytic to obtain an analytic result, comprising:
a data analyzer
a data source selected by said data analyzer; and
an analytic application selected by said data analyzer.

75. The KStore system for performing an analytic of claim 74, wherein said KStore system includes a plurality of data sources further comprising a selected data source selected from said plurality of data sources by said data analyzer.

76. The KStore system for performing an analytic of claim 74, wherein said KStore system includes a plurality of analytic applications further comprising a selected analytic application selected from said plurality of analytic applications by said data analyzer.

77. The KStore system for performing an analytic of claim 74, wherein said KStore system includes a plurality of data sources and a plurality of analytics further comprising a selected data source selected from said plurality of data sources by said data analyzer and a selected analytic application selected from said plurality of analytic applications by said data analyzer.

78. The KStore system for performing an analytic of claim 77, wherein said KStore system includes an API utility for providing instructions to said data analyzer regarding the selection of at least one of said selected data source or said selected analytic application.

79. The KStore system for performing an analytic of claim 77, wherein said selected analytic comprises an analytic from the accounting/mathematical functional category of analytics.

80. The KStore system for performing an analytic of claim 77, wherein said selected analytic comprises an analytic from the statistical functional category of analytics.

81. The KStore system for performing an analytic of claim 77, wherein said selected analytic comprises an analytic from the classification functional category of analytics.

82. The KStore system for performing an analytic of claim 77, wherein said selected analytic comprises an analytic from the relationship functional category of analytics.

83. The KStore system for performing an analytic of claim 77, wherein said selected analytic comprises an analytic from the visualization functional category of analytics.

84. The KStore system for performing an analytic of claim 77, wherein said selected analytic comprises an analytic from the meta-data functional category of analytics.

85. The KStore system for performing an analytic of claim 74, further comprising storage for storing at least one category of analytics and the members of said at least one category.
